(19) United States
(12) Patent Application Publication
(10) Pub. No.: US 2014/0090444 A1
(43) Pub. Date: Apr. 3, 2014

(54) Measurement Apparatus Having Weight Measurement Function, Display Device, and Weight Measurement System

(71) Applicant: Funai Electric Co., Ltd, Osaka (JP)

(72) Inventors: Takehiro ONOMATSU, Daito-shi (JP); Tomohiro YAMAMOTO, Daito-shi (JP)

(73) Assignee: Funai Electric Co., Ltd, Osaka (JP)

(21) Appl. No.: 14/041,504

(22) Filed: Sep. 30, 2013

(30) Foreign Application Priority Data
Oct. 1, 2012 (JP) 2012-219856
Sep. 4, 2013 (JP) 2013-182763

(51) Int. Cl. G01G 19/44; G01G 23/01

(52) U.S. Cl. CPC G01G 19/44; G01G 23/01
USPC 73/1.13

(57) ABSTRACT

This measurement apparatus having a weight measurement function outputs a weight measurement result before calibration after measuring the weight of a user before calibration, measures reference weight for calibration in a state where the user does not get on a measurement apparatus body, and outputs a weight measurement result of the user after calibration.

### BACKGROUND OF THE INVENTION

1. Field of the Invention

The present invention relates to a measurement apparatus having a weight measurement function, a display device, and a weight measurement system, and more particularly, it relates to a measurement apparatus having a weight measurement function, performing calibration, a display device, and a weight measurement system.

2. Description of the Background Art

A measurement apparatus having a weight measurement function, performing calibration is known in general, as disclosed in International Patent Application Publication WO2010/073682.

International Patent Application Publication WO2010/073682 discloses a weight measuring device configured to measure the weight of a user, employing a previously set 0 kg reference value instead of calibration. Thus, the time required to start measurement is reduced as compared with the case where calibration is performed. Furthermore, this weight measuring device is configured to acquire the 0 kg reference value, employing accumulated calibration results, by making a normal measurement in which calibration is performed at least ten times before the user gets on a body composition meter.

However, this weight measuring device must perform calibration until the weight measuring device acquires the 0 kg reference value before the user gets on the body composition meter, and hence it disadvantageously takes a long time to start measurement.

### SUMMARY OF THE INVENTION

The present invention has been proposed in order to solve the aforementioned problem, and an object of the present invention is to propose a technology to be capable of promptly starting measurement and providing a user with an accurate measurement result in which calibration has been reflected in a measurement apparatus having a weight measurement function, a display device, and a weight measurement system.

A measurement apparatus having a weight measurement function according to a first aspect of the present invention includes a measurement apparatus body, a measurement portion measuring weight, and a measurement apparatus side control portion controlling a weight measurement operation performed by the measurement portion, while the measurement apparatus side control portion is configured to perform control of outputting a weight measurement result before calibration after measuring the weight of a user before calibration in a state where the user gets on the measurement apparatus body and measuring reference weight for calibration in a state where the user does not get on the measurement apparatus body and to perform control of acquiring a weight measurement result of the user after calibration on the basis of a difference between the weight of the user before calibration in the state where the user gets on the measurement apparatus body and the reference weight for calibration and outputting the weight measurement result after calibration.

As hereinabove described, the measurement apparatus having a weight measurement function according to the first aspect of the present invention is provided with the control portion performing control of measuring the reference weight for calibration in the state where the user does not get on the measurement apparatus body after measuring the weight before calibration in the state where the user gets on the measurement apparatus, whereby the weight measurement of the user can be started before the calibration is performed, and hence the measurement can be promptly started. Furthermore, the control portion performs control of acquiring the weight measurement result of the user after calibration on the basis of the difference between the weight before calibration in the state where the user gets on the measurement apparatus body and the reference weight for calibration after measuring the weight before calibration in the state where the user gets on the measurement apparatus body, whereby the weight measurement result of the user after calibration based on the difference between the weight before calibration and the reference weight for calibration can be acquired after the measurement, and hence the user can be provided with an accurate measurement result in which calibration has been reflected. Therefore, in this measurement apparatus having a weight measurement function, the measurement can be promptly started, and the user can be provided with an accurate measurement result in which calibration has been reflected.

The aforementioned measurement apparatus having a weight measurement function according to the first aspect preferably further includes a detection portion detecting that the user has gotten on the measurement apparatus body, and the measurement apparatus side control portion is preferably configured to perform control of powering on the measurement apparatus body when the detection portion detects that the user has gotten on the measurement apparatus body. According to this structure, the measurement apparatus body can be powered on at the timing when the user gets on the measurement apparatus body, and hence useless power consumption can be suppressed, unlike the case where the measurement apparatus body is previously powered on before the user gets on the measurement apparatus body. Therefore, a reduction in battery power can be suppressed when the measurement apparatus is driven by the battery. Furthermore, the user simply gets on and off the measurement apparatus body, whereby the reference weight for calibration in the state where the user does not get on the measurement apparatus body can be measured after the weight before calibration is measured, and the weight measurement result of the user after calibration can be acquired on the basis of the difference between the weight before calibration in the state where the user gets on the measurement apparatus body and the reference weight for calibration. Thus, the measurement can be easily promptly started, and the user can be provided with an accurate measurement result in which calibration has been reflected.

The aforementioned measurement apparatus having a weight measurement function according to the first aspect preferably further includes a measurement apparatus side communication portion capable of communicating with an external display device, and the measurement apparatus side control portion is preferably configured to perform control of transmitting the weight measurement result after calibration to the external display device through the measurement apparatus side communication portion after transmitting the weight measurement result before calibration to the external display device. According to this structure, no display portion configured to display the weight measurement results may be provided in the measurement apparatus having a weight measurement function, and hence the structure of the measurement apparatus having a weight measurement function can be simplified. Furthermore, the weight measurement results can be displayed on the external display device, and hence the user can be provided with the weight measurement results in a more visually-recognizable state.

The aforementioned measurement apparatus having a weight measurement function according to the first aspect preferably further includes a measurement apparatus side communication portion capable of communicating with an external storage device, and the measurement apparatus side control portion is preferably configured to perform control of transmitting the weight measurement result after calibration to the external storage device through the measurement apparatus side communication portion after transmitting the weight measurement result before calibration to the external storage device. According to this structure, no storage portion configured to store measurement data may be provided in the measurement apparatus having a weight measurement function, and hence the structure of the measurement apparatus having a weight measurement function can be simplified.

A display device according to a second aspect of the present invention includes a display portion, a display device side receiving portion receiving a measurement result of reference weight for calibration in a state where a user does not get on a measurement apparatus body from a measurement apparatus having a weight measurement function after receiving a weight measurement result before calibration in a state where the user gets on the measurement apparatus body from the measurement apparatus having a weight measurement function, and a display device side control portion controlling a display operation displayed on the display portion, while the display device side control portion is configured to perform control of displaying the weight measurement result before calibration on the display portion, acquiring a weight measurement result of the user after calibration on the basis of a difference between the weight measurement result before calibration and the reference weight for calibration, and displaying the weight measurement result after calibration on the display portion.

As hereinabove described, the display device according to the second aspect of the present invention is provided with the display device side receiving portion receiving the measurement result of the reference weight for calibration in the state the user does not get on the measurement apparatus body from the measurement apparatus having a weight measurement function after receiving the weight measurement result before calibration in the state where the user gets on the measurement apparatus body from the measurement apparatus having a weight measurement function, whereby the weight measurement of the user can be started before the calibration is performed, and hence the measurement can be promptly started. Furthermore, the display device is provided with the display device side control portion performing control of acquiring the weight measurement result of the user after calibration on the basis of the difference between the weight before calibration in the state where the user gets on the measurement apparatus body and the reference weight for calibration after receiving the weight measurement result before calibration in the state where the user gets on the measurement apparatus body from the measurement apparatus having a weight measurement function, whereby the weight measurement result of the user after calibration based on the difference between the weight before calibration and the reference weight for calibration can be acquired after the measurement, and hence the user can be provided with an accurate measurement result in which calibration has been reflected. Therefore, in this display device, the measurement can be promptly started, and the user can be provided with an accurate measurement result in which calibration has been reflected. In addition, the display device side control portion performs arithmetic processing to acquire the weight of the user after calibration on the basis of the difference between the weight measurement result before calibration and the reference weight for calibration, whereby it is not necessary for the measurement apparatus having a weight measurement function to perform the aforementioned arithmetic processing, and hence the structure of the measurement apparatus having a weight measurement function can be simplified. Furthermore, the display device is provided with the display portion configured to display the weight measurement result before calibration and the weight measurement result after calibration, whereby no display portion configured to display the weight measurement results may be provided in the measurement apparatus having a weight measurement function, and hence complication of the structure of the measurement apparatus having a weight measurement function can be suppressed. In addition, the weight measurement results can be displayed on the display device, and hence the user can be provided with the weight measurement results in a more visually-recognizable state.

The aforementioned display device according to the second aspect preferably further includes a remote controller configured to operate a display device body, and the display device side control portion is preferably configured to perform control of shifting to a weight measurement mode configured to measure the weight of the user on the basis of the user's operation of the remote controller. According to this structure, a shift to the weight measurement mode can be made with the remote controller configured to operate the display device body, and hence no operation portion for shifting the display device to the weight measurement mode may be provided in the measurement apparatus. Consequently, complication of the structure of the measurement apparatus having a weight measurement function can be suppressed.

In this case, the display device side control portion is preferably configured to perform control of displaying an inquiry to the user about clothing worn by the user on the display portion, estimating the weight of the user in the case where the user wears no clothing on the basis of the response of the user to the inquiry with the remote controller, and displaying a measurement result of the weight of the user in the case where the user wears no clothing on the display portion in the weight measurement mode. According to this structure, the user can be provided with an accurate measurement result from which the weight of the clothing has been subtracted even when the user wears the clothing.

In the aforementioned display device displaying the measurement result of the weight of the user in the case where the user wears no clothing on the display portion, the display device side control portion is preferably configured to perform control of acquiring a difference between a first weight measurement result that is the weight measurement result before calibration and a second weight measurement result that is a weight measurement result before calibration prior to the weight measurement result before calibration and displaying the measurement result of the weight of the user in the case where the user wears no clothing on the display portion on the basis of the weight of the clothing at the time of acquisition of the second weight measurement result without displaying the inquiry when the difference is not larger than a prescribed threshold. According to this structure, in the case where the user wears the same clothing at the time of measurement of the first weight measurement result and at the time of measurement of the second weight measurement result and the difference value is small, display of the inquiry can be omitted, and hence a need for the user to respond to the inquiry can be eliminated while the weight of the clothing is considered. Consequently, the time required for one measurement can be reduced.

In this case, the display device side control portion is preferably configured to perform control of acquiring the difference between the first weight measurement result that is the weight measurement result before calibration and the second weight measurement result that is the weight measurement result before calibration prior to the weight measurement result before calibration, displaying the inquiry when the difference is larger than the prescribed threshold, and displaying the measurement result of the weight of the user in the case where the user wears no clothing on the display portion on the basis of the response of the user to the inquiry with the remote controller. According to this structure, only in the case where the difference value is large and the user conceivably wears different clothing at the time of measurement of the first weight measurement result and at the time of measurement of the second weight measurement result, the inquiry is displayed, and hence display of the inquiry can be omitted in the other cases. Consequently, a need for the user to respond to the inquiry can be eliminated while the weight of the clothing is considered, and hence the time required for one measurement can be reduced.

In the aforementioned display device according to the second aspect, the display device side control portion is preferably configured to perform control of shifting to a setting change mode configured to set whether or not to measure the weight of the user in the case where the user wears no clothing and set the weight of the clothing on the basis of the user's operation of the remote controller. According to this structure, the user himself/herself can determine whether or not to measure the weight of the user in the case where the user wears no clothing, and hence the user can be provided with the measurement result according to the request of the user. Furthermore, the weight of the clothing that the user owns can be set, and hence the user can be provided with an accurate measurement result from which the weight of the clothing has been subtracted.

The aforementioned display device according to the second aspect preferably further includes an imaging portion imaging the clothing of the user, and the display device side control portion is preferably configured to perform control of selectably displaying a plurality of images of clothing previously imaged by the imaging portion at the time of the inquiry, estimating the weight of the user in the case where the user does not wear clothing of a selected image on the basis of the selected image, and displaying the measurement result of the weight of the user in the case where the user does not wear the clothing of the selected image on the display portion. According to this structure, an image of the clothing can be displayed and selected, and hence the inquiry can be displayed in a more visually-recognizable state for the user. Furthermore, unlike the case where the weight of the user wearing no clothing is estimated on a rough basis of summer clothing and winter clothing, the clothing can be specified by the image of the clothing actually worn by the user, and hence the weight of the user wearing no clothing can be more accurately estimated.

The aforementioned display device according to the second aspect preferably further includes a display device side communication portion capable of communicating with an external storage device and is preferably configured to receive the weight measurement result before calibration and the measurement result of the reference weight for calibration from the external storage device through the display device side communication portion. According to this structure, the display device can receive the weight measurement result previously stored in the external storage device, and hence it is not necessary for the display device to store the measurement data. Thus, no storage portion configured to store the measurement data may be provided in the display device, and hence the structure of the display device can be simplified. Furthermore, the display device receives the weight measurement result previously stored in the external storage device, whereby even the display device not retaining a past weight measurement result can display that weight measurement result, and hence the display device convenient to the user can be provided.

A weight measurement system according to a third aspect of the present invention includes a measurement apparatus having a weight measurement function, including a measurement apparatus body, a measurement portion measuring weight, and a measurement apparatus side control portion performing control of outputting a weight measurement result before calibration after measuring the weight of a user before calibration in a state where the user gets on the measurement apparatus body and measuring reference weight for calibration in a state where the user does not get on the measurement apparatus body and a display device including a display portion, a display device side receiving portion receiving a measurement result from the measurement apparatus having a weight measurement function, and a display device side control portion controlling a display operation displayed on the display portion, while either the measurement apparatus side control portion or the display device side control portion is configured to perform control of acquiring a weight measurement result of the user after calibration on the basis of a difference between the weight of the user before calibration in a state where the user gets on the measurement apparatus body measured by the measurement portion and the reference weight for calibration, and the display device side control portion is configured to perform control of displaying the weight measurement result after calibration on the display portion after displaying the weight measurement result before calibration on the display portion.

As hereinabove described, the weight measurement system according to the third aspect of the present invention is provided with the measurement apparatus side control portion performing control of measuring the reference weight for calibration in the state where the user does not get on the measurement apparatus body after measuring the weight of the user before calibration in the state where the user gets on the measurement apparatus body, whereby the weight measurement of the user can be started before the calibration is performed, and hence the measurement can be promptly started. Furthermore, the weight measurement system is provided with the measurement apparatus side control portion or the display device side control portion performing control of acquiring the weight measurement result of the user after calibration on the basis of the difference between the weight before calibration in the state where the user gets on the measurement apparatus body and the reference weight for calibration after measuring the weight before calibration in the state where the user gets on the measurement apparatus body, whereby the weight measurement result of the user after calibration based on the difference between the weight before calibration and the reference weight for calibration can be acquired after the measurement, and hence the user can be provided with an accurate measurement result in which calibration has been reflected. Therefore, in this weight measurement system, the measurement can be promptly started, and the user can be provided with an accurate measurement result in which calibration has been reflected. In addition, the display device is provided with the display portion configured to display the weight measurement result before calibration and the weight measurement result after calibration, whereby no display portion configured to display the weight measurement results may be provided in the measurement apparatus having a weight measurement function, and hence complication of the structure can be suppressed. Furthermore, the weight measurement results can be displayed on the display device, and hence the user can be provided with the weight measurement results in a more visually-recognizable state.

The aforementioned weight measurement system according to the third aspect preferably further includes a detection portion detecting that the user has gotten on the measurement apparatus body, and the measurement apparatus side control portion is preferably configured to perform control of powering on the measurement apparatus body when the detection portion detects that the user has gotten on the measurement apparatus body. According to this structure, the measurement apparatus body can be powered on at the timing when the user gets on the measurement apparatus body, and hence useless power consumption can be suppressed, unlike the case where the measurement apparatus body is previously powered on before the user gets on the measurement apparatus body. Therefore, a reduction in battery power can be suppressed when the measurement apparatus is driven by the battery. Furthermore, the user simply gets on and off the measurement apparatus body, whereby the reference weight for calibration in the state where the user does not get on the measurement apparatus body can be measured after the weight before calibration in the state where the user gets on the measurement apparatus body is measured, and the weight measurement result of the user after calibration can be acquired on the basis of the difference between the weight before calibration in the state where the user gets on the measurement apparatus body and the reference weight for calibration. Thus, the measurement can be easily promptly started, and the user can be provided with an accurate measurement result in which calibration has been reflected.

In the aforementioned weight measurement system according to the third aspect, the display device preferably includes at least one of a stationary television set and a portable terminal device. According to this structure, the weight measurement results can be easily displayed on the stationary television set or the portable terminal device without separately providing a dedicated external display device.

In this case, the weight measurement system preferably further includes a remote controller configured to operate the stationary television set as the display device, and the display device side control portion is preferably configured to perform control of shifting to a weight measurement mode configured to measure the weight of the user on the basis of the user's operation of the remote controller. According to this structure, a shift to the weight measurement mode can be made with the remote controller configured to operate the display device body, and hence no operation portion for shifting the display device to the weight measurement mode may be provided in the measurement apparatus. Consequently, complication of the structure of the measurement apparatus having a weight measurement function can be suppressed.

In this case, the display device side control portion is preferably configured to perform control of displaying an inquiry to the user about clothing worn by the user on the display portion, estimating the weight of the user in the case where the user wears no clothing on the basis of the response of the user to the inquiry with the remote controller, and displaying a measurement result of the weight of the user on the display portion in the weight measurement mode. According to this structure, the user can be provided with an accurate measurement result from which the weight of the clothing has been subtracted even when the user wears the clothing.

In this case, the display device side control portion is preferably configured to perform control of acquiring a difference between a first weight measurement result that is the weight measurement result before calibration and a second weight measurement result that is a weight measurement result before calibration prior to the weight measurement result before calibration and displaying the measurement result of the weight of the user in the case where the user wears no clothing on the display portion on the basis of weight of the clothing at the time of acquisition of the second weight measurement result without displaying the inquiry when the difference is not larger than a prescribed threshold. According to this structure, in the case where the user wears the same clothing at the time of measurement of the first weight measurement result and at the time of measurement of the second weight measurement result and the difference value is small, display of the inquiry can be omitted, and hence a need for the user to respond to the inquiry can be eliminated while the weight of the clothing is considered. Consequently, the time required for one measurement can be reduced.

In the aforementioned structure including at least one of the stationary television set and the portable terminal device, the measurement apparatus side control portion is preferably configured to perform control of transmitting at least the weight measurement result before calibration in the state where the user gets on the measurement apparatus body to the portable terminal device in the case where the stationary television set is not recognized when transmitting at least the weight measurement result before calibration in the state where the user gets on the measurement apparatus body to the stationary television set. According to this structure, the weight measurement result before calibration and the weight measurement result after calibration acquired by the measurement apparatus having a weight measurement function or the portable terminal device can be displayed on the portable terminal device even when the stationary television set is not recognized.

The aforementioned weight measurement system according to the third aspect preferably further includes an external storage device side receiving portion receiving a measurement result from the measurement apparatus having a weight measurement function, a storage portion storing the measurement result received by the external storage device side receiving portion, an external storage device side transmitting portion transmitting the measurement result stored in the storage portion to the display device, and an external storage device provided separately from the measurement apparatus and the display device. According to this structure, no storage portion may be provided in each of the measurement apparatus and the display device, and hence the structure of the measurement apparatus and the structure of the display device can be simplified. In addition, even the display device different from the display device that has displayed the weight measurement results in the past can display those weight measurement results, and hence the display device convenient to the user can be provided.

According to the present invention, as hereinabove described, the measurement can be promptly started, and the user can be provided with an accurate measurement result in which calibration has been reflected.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual diagram showing the overall structure of a weight measurement system according to a first embodiment of the present invention;

FIG. 2 is a block diagram showing the structure of the weight measurement system according to the first embodiment of the present invention;

FIG. 3 is a diagram showing a weight measurement start screen of the weight measurement system according to the first embodiment of the present invention;

FIG. 4 is a diagram showing a clothing confirmation screen of the weight measurement system according to the first embodiment of the present invention;

FIG. 5 is a diagram showing a weight display screen before calibration of the weight measurement system according to the first embodiment of the present invention;

FIG. 6 is a diagram showing a weight display screen after calibration of the weight measurement system according to the first embodiment of the present invention;

FIG. 7 is a diagram showing a weight change history screen of the weight measurement system according to the first embodiment of the present invention;

FIG. 8 is a diagram showing a program guide screen of the weight measurement system according to the first embodiment of the present invention;

FIG. 9 is a flowchart for illustrating weight measurement processing performed by the weight measurement system according to the first embodiment of the present invention;

FIG. 10 is a flowchart for illustrating the weight measurement processing performed by the weight measurement system according to the first embodiment of the present invention;

FIG. 11 is a conceptual diagram showing the overall structure of a weight measurement system according to a modification of the first embodiment of the present invention;

FIG. 12 is a diagram showing a state where weight measurement results before and after calibration are displayed on a display portion of the weight measurement system according to the modification of the first embodiment of the present invention;

FIG. 13 is a block diagram showing the structure of a weight measurement system according to a second embodiment of the present invention;

FIG. 14 is a diagram showing a setting change menu screen of the weight measurement system according to the second embodiment of the present invention;

FIG. 15 is a diagram showing a clothing weight change screen of the weight measurement system according to the second embodiment of the present invention;

FIG. 16 is a diagram showing a numerical value setting screen of the weight measurement system according to the second embodiment of the present invention;

FIG. 17 is a diagram showing a weight display screen before calibration of the weight measurement system according to the second embodiment of the present invention;

FIG. 18 is a diagram showing a clothing selection screen of the weight measurement system according to the second embodiment of the present invention;

FIG. 19 is a flowchart for illustrating weight measurement processing performed by the weight measurement system according to the second embodiment of the present invention;

FIG. 20 is a flowchart for illustrating the weight measurement processing performed by the weight measurement system according to the second embodiment of the present invention;

FIG. 21 is a flowchart for illustrating setting change processing performed by the weight measurement system according to the second embodiment of the present invention;

FIG. 22 is a conceptual diagram showing the overall structure of a weight measurement system according to a third embodiment of the present invention;

FIG. 23 is a block diagram showing the structure of the weight measurement system according to the third embodiment of the present invention;

FIG. 24 is a flowchart for illustrating weight measurement processing performed by the weight measurement system according to the third embodiment of the present invention;

FIG. 25 is a flowchart for illustrating the weight measurement processing performed by the weight measurement system according to the third embodiment of the present invention; and

FIG. 26 is a flowchart for illustrating the weight measurement processing performed by the weight measurement system according to the third embodiment of the present invention.

### DESCRIPTION OF THE PREFERRED EMBODIMENTS

The present invention is applicable to a measurement apparatus having a weight measurement function, performing calibration, but a weight measurement system is hereinafter described as a specific example to which the present invention is applied.

### First Embodiment

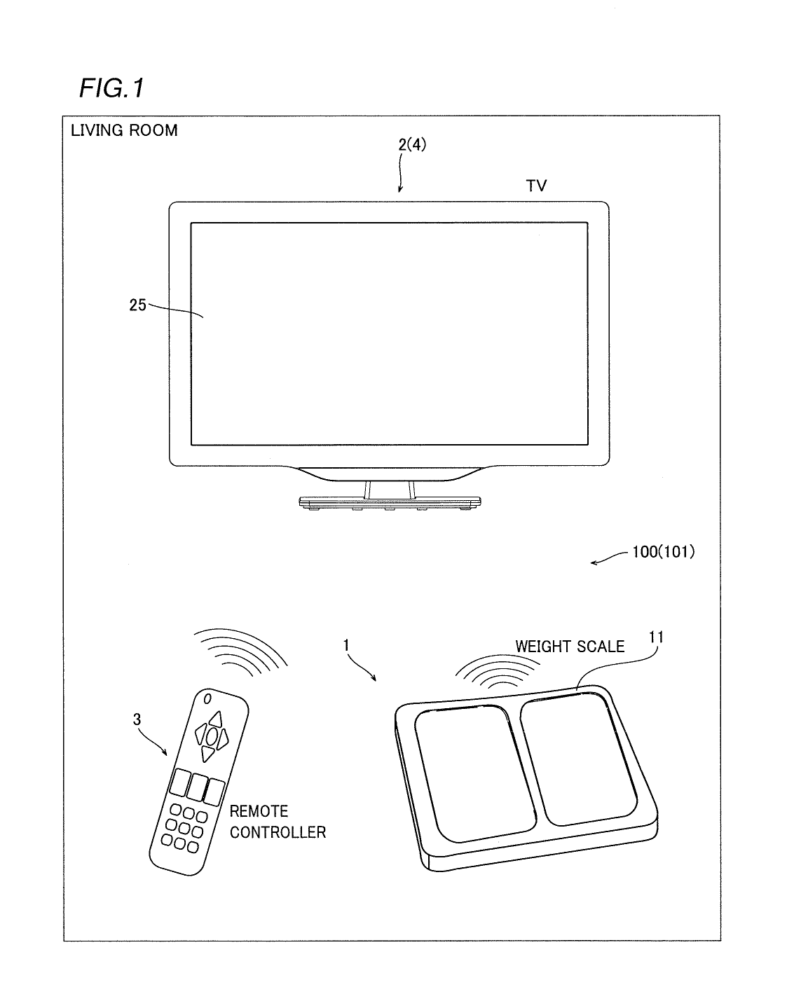

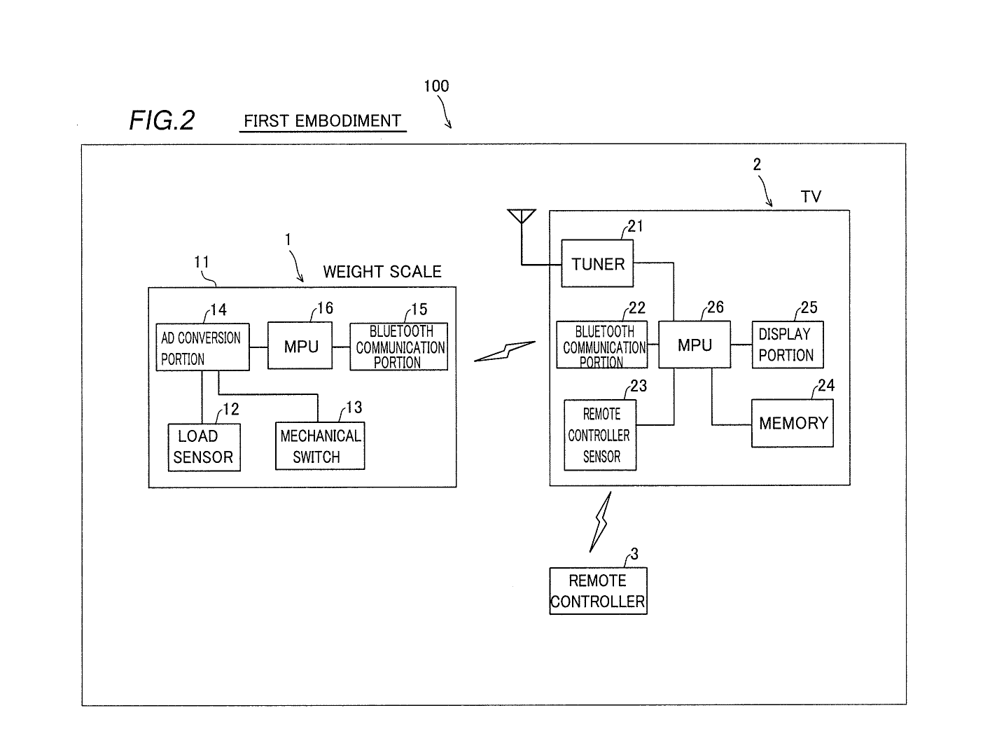

FIGS. 1 and 2 show a weight measurement system 100 according to a first embodiment of the present invention.

The weight measurement system 100 according to the first embodiment includes a weight scale 1, a stationary TV (television set) 2, and a remote controller 3. The weight scale 1 is configured to be portable. The TV 2 is configured to be remote controllable by the remote controller 3. As shown in FIG. 1, the weight measurement system 100 is arranged in a living room to be employed, for example. This weight measurement system 100 is configured to be capable of displaying a measurement result acquired by the weight scale 1 on the TV 2. The weight scale 1 is an example of the “measurement apparatus having a weight measurement function” in the present invention. The TV 2 is an example of the “display device” or the “external display device” in the present invention.

According to the first embodiment, the weight scale 1 is driven by an unshown battery and includes a weight scale body 11, a load sensor 12 measuring weight, a mechanical switch 13, an AD (analog to digital) conversion portion 14, a Bluetooth (registered trademark) communication portion 15 capable of communicating with the TV 2, and an MPU (micro-processing unit) 16, as shown in FIG. 2. The weight scale body 11 is an example of the “measurement apparatus body” in the present invention. The load sensor 12 is an example of the “measurement portion” in the present invention. The mechanical switch 13 is an example of the “detection portion” in the present invention. The Bluetooth (registered trademark) communication portion 15 is an example of the “measurement apparatus side communication portion” in the present invention. The MPU 16 is an example of the “measurement apparatus side control portion” in the present invention.

The load sensor 12 is configured to measure the weight of a user getting on the weight scale body 11. The mechanical switch 13 is configured to be turned on when detecting that the user has gotten on the weight scale body 11. The AD conversion portion 14 is configured to convert the weight of the user detected by the load sensor 12 and that the mechanical switch 13 has been turned on into digital signals and to transmit the digital signals to the MPU 16.

According to the first embodiment, the MPU 16 is configured to control a weight measurement operation performed by the load sensor 12. The MPU 16 is configured to perform control of outputting a weight measurement result before calibration after measuring the weight before calibration in a state where the user gets on the weight scale body 11 and measuring reference weight for calibration in a state where the user does not get on the weight scale body 11.

Specifically, the MPU 16 is configured to perform control of powering on the weight scale body 11 when the mechanical switch 13 detects that the user has gotten on the weight scale body 11. The MPU 16 is configured to control the load sensor 12 to measure the weight of the user before calibration. Furthermore, the MPU 16 is configured to perform control of outputting the weight of the user before calibration to the TV 2 through the Bluetooth (registered trademark) communication portion 15. The MPU 16 is configured to control the load sensor 12 to measure the reference weight for calibration in the state where the user does not get on the weight scale body 11 after the user gets off the weight scale body 11. In addition, the MPU 16 is configured to perform control of outputting the reference weight for calibration to the TV 2 through the Bluetooth (registered trademark) communication portion 15.

According to the first embodiment, the TV 2 includes a tuner 21, a Bluetooth (registered trademark) communication portion 22, a remote controller sensor 23, a memory 24, a display portion 25, and an MPU 26, as shown in FIG. 2. The Bluetooth (registered trademark) communication portion 22 is an example of the “display device side receiving portion” in the present invention. The MPU 26 is an example of the “display device side control portion” in the present invention.

The tuner 21 is configured to be capable of receiving a broadcast signal. The Bluetooth (registered trademark) communication portion 22 is configured to receive the measurement result from the Bluetooth (registered trademark) communication portion 15 of the weight scale 1. The tuner 21 is configured to receive a measurement result of the reference weight for calibration in the state where the user does not get on the weight scale body 11 from the weight scale 1 after receiving the weight measurement result before calibration in the state where the user gets on the weight scale body 11 from the weight scale 1.

According to the first embodiment, the remote controller sensor 23 is configured to be capable of receiving an infrared signal from the remote controller 3. The memory 24 is configured to store data on a measurement result of the weight of the user. The display portion 25 is configured to display the data on the measurement result of the weight of the user, a television program, etc. A display operation displayed on the display portion 25 is controlled by the MPU 26.

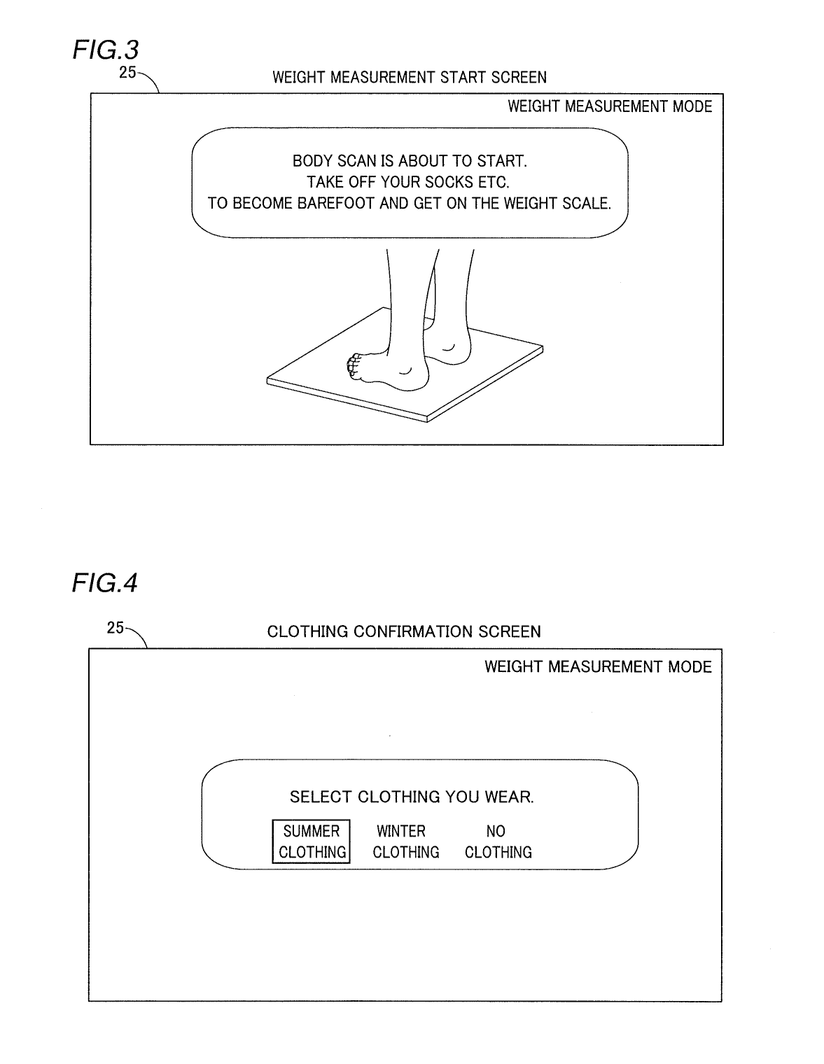

According to the first embodiment, the MPU 26 (see FIG. 2) is configured to perform control of shifting to a weight measurement mode (see FIG. 3) configured to measure the weight of the user on the basis of the user's operation of the remote controller 3. Specifically, the MPU 26 is configured to perform control of displaying a weight measurement start screen and starting measurement of the weight of the user when the user gets on the weight scale body 11.

According to the first embodiment, the MPU 26 is configured to perform control of displaying a clothing confirmation screen for inquiring of the user about the clothing worn by the user on the display portion 25, estimating the weight of the user in the case where the user wears no clothing on the basis of the response of the user to the inquiry with the remote controller 3, and displaying the measurement result of the weight of the user in the case where the user wears no clothing on the display portion 25 in the weight measurement mode. Specifically, the MPU 26 is configured to make an inquiry allowing the user to select whether the user wears “summer clothing”, “winter clothing”, or “no clothing” through the clothing confirmation screen, as shown in FIG. 4. For example, the MPU 26 is configured to perform control of subtracting the weight (1.0 kg, for example) of general summer clothing from the weight of the user before calibration when the user selects the “summer clothing” and to perform control of subtracting the weight (2.0 kg, for example) of general winter clothing from the weight of the user before calibration when the user selects the “winter clothing”.

Specifically, the MPU 26 is configured to perform control of displaying the weight measurement result before calibration from which the weight of the clothing worn by the user has been subtracted on a weight display screen before calibration when receiving the weight measurement result before calibration from the weight scale 1, as shown in FIG. 5. When the weight of the user measured by the weight scale 1 is 61.2 kg and the user selects the “summer clothing” as the clothing worn by the user, for example, 1.0 kg set as the weight of the summer clothing is subtracted from 61.2 kg, which is the measured weight of the user, and 60.2 kg is displayed as the weight measurement result before calibration on the weight display screen before calibration.

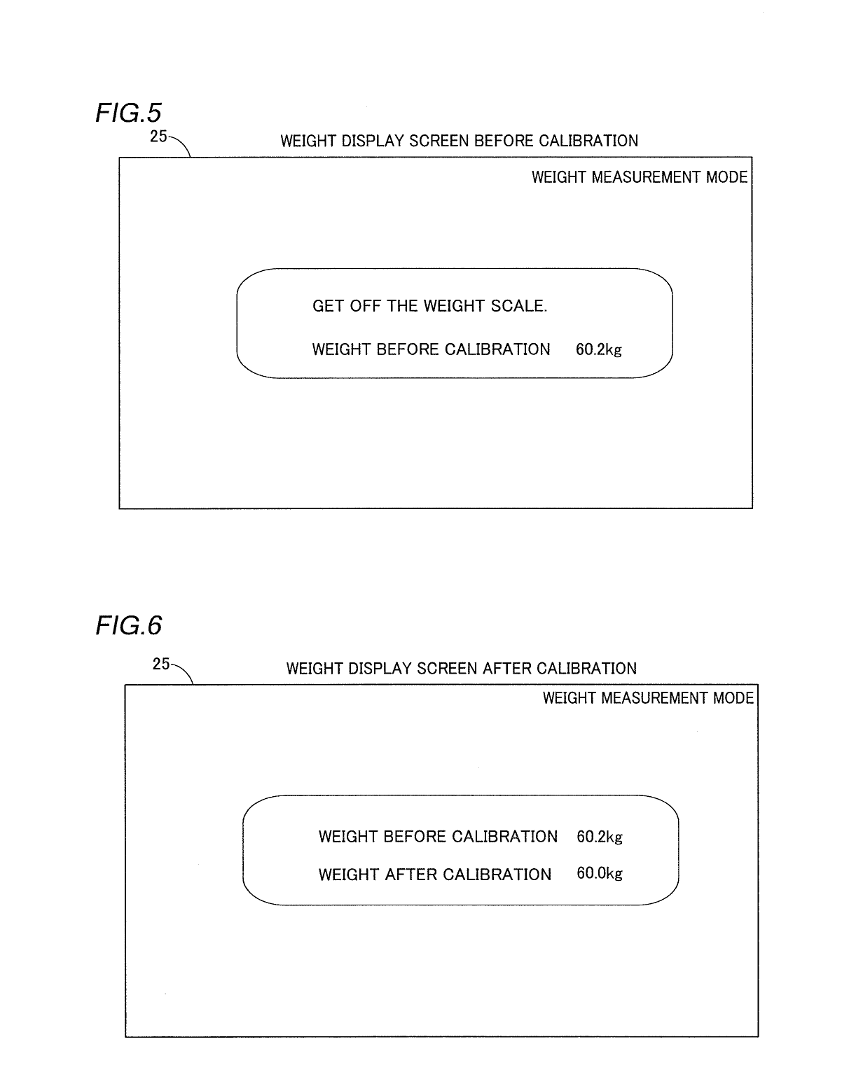

According to the first embodiment, the MPU 26 is configured to perform control of acquiring a weight measurement result of the user after calibration on the basis of a difference between the weight before calibration in the state where the user gets on the weight scale body 11 measured by the load sensor 12 and the reference weight for calibration, as shown in FIG. 6. Furthermore, the MPU 26 is configured to perform control of displaying the weight measurement result after calibration after displaying the weight measurement result before calibration on the weight display screen before calibration and a weight display screen after calibration, as shown in FIGS. 5 and 6. In addition, the MPU 26 is configured to perform control of displaying the weight measurement result before calibration and the weight measurement result after calibration in an aligned (comparable) state on the same screen through the weight display screen after calibration, as shown in FIG. 6.

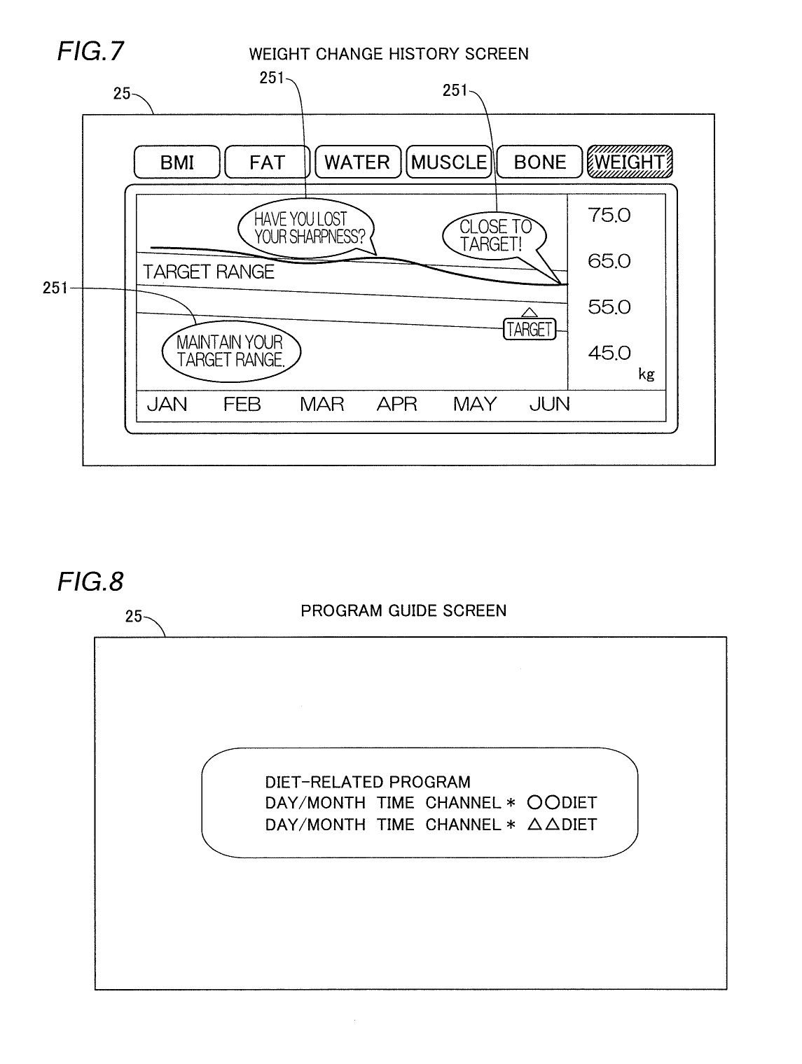

According to the first embodiment, the MPU 26 is configured to perform control of storing the weight measurement result of the user after calibration in the memory 24 (see FIG. 2). Furthermore, the MPU 26 is configured to display a weight change history screen for displaying the change in the weight of the user after calibration over time on the display portion 25 through a GUI (graphical user interface) on the basis of the weight measurement result of the user after calibration stored (accumulated) in the memory 24, as shown in FIG. 7. In addition, the MPU 26 is configured to display indications 251 such as a comment on the weight measurement result of the user and an interactive assistant (for displaying a proper advice on the basis of a target range and the transition of the measurement result) on the weight change history screen. Measurement results of a BMI (body mass index), fat (body fat), etc. measurable simultaneously with weight measurement may be collectively displayed together with the weight measurement results on the display portion 25.

The MPU 26 is configured to perform control of searching health-related programs and displaying a program guide screen on the display portion 25 on the basis of the weight measurement result of the user, as shown in FIG. 8. For example, the MPU 26 is configured to perform control of searching diet-related programs and displaying the list when the weight of the user is included in the overweight range.

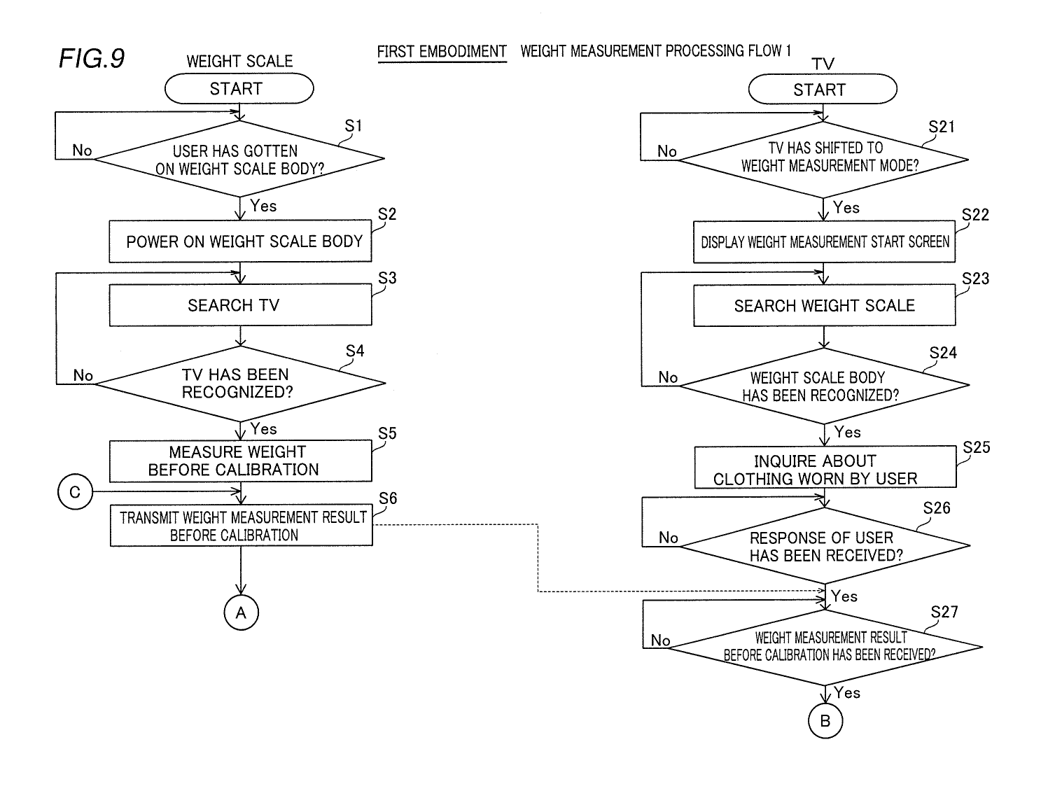

A flow of weight measurement processing performed by the weight measurement system 100 according to the first embodiment is now described with reference to FIGS. 2 and 9. Processing in the weight scale 1 is performed by the MPU 16, and processing in the TV 2 is performed by the MPU 26.

First, in the TV 2, the MPU 26 determines whether or not the TV 2 has shifted to the weight measurement mode at a step S21. Specifically, the MPU 26 determines whether or not the user operates the remote controller 3 to shift to the weight measurement mode, as shown in FIG. 3. The MPU 26 repeats this determination until the TV 2 shifts to the weight measurement mode and advances to a step S22 when the TV 2 shifts to the weight measurement mode.

At the step S22, the weight measurement start screen for instructing the user to get on the weight scale body 11 is displayed on the display portion 25. Then, the weight scale 1 is searched at a step S23.

At a step S24, the MPU 26 determines whether or not the weight scale body 11 (see FIG. 2) has been recognized. When determining that the weight scale body 11 has not been recognized at the step S24, the MPU 26 returns to the step S23. When determining that the weight scale body 11 has been recognized at the step S24, the MPU 26 advances to a step S25.

At the step S25, the inquiry about the clothing worn by the user is made to the user. Specifically, the inquiry allowing the user to select whether the user wears the “summer clothing”, the “winter clothing”, or “no clothing” through the clothing confirmation screen is displayed on the display portion 25, as shown in FIG. 4.

Then, the MPU 26 determines whether or not the response of the user about the clothing worn by the user has been received at a step S26. The MPU 26 repeats this determination until the response of the user about the clothing worn by the user is received and advances to a step S27 when the response of the user about the clothing worn by the user is received.

On the other hand, in the weight scale 1, the MPU 16 determines whether or not the user has gotten on the weight scale body 11 (see FIG. 2) at a step S1. The MPU 16 repeats this determination until the user gets on the weight scale body 11 and advances to a step S2 when the user gets on the weight scale body 11. When the mechanical switch 13 detects that the user has gotten on the weight scale body 11, the MPU 16 powers on the weight scale 1 and the weight of the user before calibration is measured.

At the step S2, the weight scale body 11 is powered on. Then, the TV 2 is searched at a step S3.

At a step S4, the MPU 16 determines whether or not the TV 2 (see FIG. 2) has been recognized. When determining that the TV 2 has not been recognized at the step S4, the MPU 16 returns to the step S3. When determining that the TV 2 has been recognized at the step S4, the MPU 16 advances to a step S5. At the step S5, the weight before calibration is measured.

At a step S6, the weight measurement result of the user before calibration is transmitted to the TV 2. Specifically, the weight measurement result of the user before calibration is transmitted from the weight scale 1 to the TV 2 through the Bluetooth (registered trademark) communication portion 15 (see FIG. 2).

In the TV 2, the MPU 26 determines whether or not the weight measurement result before calibration has been received from the weight scale 1 at a step S27. The MPU 26 repeats this determination until the weight measurement result before calibration is received from the weight scale 1 and advances to a step S28 when the weight measurement result before calibration is received from the weight scale 1.

At the step S28, a reception response indicating that the weight measurement result of the user before calibration has been received is transmitted to the TV 2. Then, at a step S29, an instruction to get off the weight scale body 11 and the weight measurement result before calibration from which the weight of the clothing has been subtracted are displayed on the display portion 25 through the weight display screen before calibration, as shown in FIG. 5.

In the weight scale 1, the MPU 16 determines whether or not the reception response of the weight measurement result of the user before calibration transmitted from the TV 2 has been received at a step S7. When determining that the reception response of the weight measurement result of the user before calibration transmitted from the TV 2 has not been received at the step S7, the MPU 16 returns to the step S6. When determining that the reception response of the weight measurement result of the user before calibration transmitted from the TV 2 has been received at the step S7, the MPU 16 advances to a step S8.

At the step S8, the MPU 16 determines whether or not the user has gotten off the weight scale body 11 through the mechanical switch 13. The MPU 16 repeats this determination until the user gets off the weight scale body 11 and advances to a step S9 when the user gets off the weight scale body 11.

At the step S9, the reference weight for calibration in the state where the user does not get on the weight scale body 11 is measured. Then, the measurement result of the reference weight for calibration is transmitted to the TV 2 at a step S10. Specifically, the measurement result of the reference weight for calibration is transmitted from the weight scale 1 to the TV 2 through the Bluetooth (registered trademark) communication portion 15.

In the TV 2, the MPU 26 determines whether or not the measurement result of the reference weight for calibration transmitted from the weight scale 1 has been received at a step S30. The MPU 26 repeats this determination until the measurement result of the reference weight for calibration is received and advances to a step S31 when the measurement result of the reference weight for calibration is received.

At the step S31, a reception response indicating that the measurement result of the reference weight for calibration has been received is transmitted to the TV 2. Then, the weight after calibration is acquired on the basis of the reference weight for calibration and is displayed at a step S32. Specifically, the reference weight for calibration is subtracted from the weight before calibration, whereby the weight measurement result after calibration is acquired. Then, the weight after calibration is displayed on the display portion 25 through the weight display screen after calibration, as shown in FIG. 6. Thereafter, a flow of measurement result acquisition processing is terminated.

In the weight scale 1, the MPU 16 determines whether or not the reception response of the measurement result of the reference weight for calibration has been received from the TV 2 at a step S11. When determining that the reception response of the measurement result of the reference weight for calibration has not been received from the TV 2 at the step S11, the MPU 16 returns to the step S10. When determining that the reception response of the measurement result of the reference weight for calibration has been received from the TV 2 at the step S11, the MPU 16 advances to a step S12. At the step S12, the weight scale 1 is powered off, and thereafter the flow of the weight measurement processing is terminated.

According to the first embodiment, the following effects can be obtained.

According to the first embodiment, as hereinabove described, the weight scale 1 is provided with the MPU 16 performing control of measuring the reference weight for calibration in the state where the user does not get on the weight scale body 11 after measuring the weight before calibration in the state where the user gets on the weight scale body 11. Thus, the weight measurement of the user can be started before the calibration is performed, and hence the measurement can be promptly started. Furthermore, the weight scale 1 is provided with the MPU 16 performing control of acquiring the weight measurement result of the user after calibration on the basis of the difference between the weight before calibration in the state where the user gets on the weight scale body 11 and the reference weight for calibration after measuring the weight before calibration in the state where the user gets on the weight scale body 11. Thus, the weight measurement result of the user after calibration is acquired after the measurement, and hence the user can be provided with an accurate measurement result in which calibration has been reflected. Therefore, in this weight measurement system, the measurement can be promptly started, and the user can be provided with an accurate measurement result in which calibration has been reflected. In addition, the TV 2 is provided with the display portion 25 configured to display the weight measurement result before calibration and the weight measurement result after calibration, whereby no display portion configured to display the weight measurement results may be provided in the weight scale 1, and hence complication of the structure can be suppressed.

Furthermore, the weight measurement results can be displayed on the TV 2, and hence the user can be provided with the weight measurement results in a more visually-recognizable state.

According to the first embodiment, as hereinabove described, the weight scale 1 is further provided with the mechanical switch 13 detecting that the user has gotten on the weight scale body 11, and the MPU 16 is configured to perform control of powering on the weight scale body 11 when the mechanical switch 13 detects that the user has gotten on the weight scale body 11. Thus, the weight scale body 11 can be powered on at the timing when the user gets on the weight scale body 11, and hence useless power consumption can be suppressed, unlike the case where the weight scale body 11 is previously powered on before the user gets on the weight scale body 11. Therefore, a reduction in battery power can be suppressed when the weight scale 1 is driven by the battery. Furthermore, the user simply gets on and off the weight scale body 11, whereby the reference weight for calibration in the state where the user does not get on the weight scale body 11 can be measured after the weight before calibration in the state where the user gets on the weight scale body 11 is measured, and the weight measurement result of the user after calibration can be acquired on the basis of the difference between the weight before calibration in the state where the user gets on the weight scale body 11 and the reference weight for calibration. Thus, the measurement can be easily promptly started, and the user can be provided with an accurate measurement result in which calibration has been reflected.

According to the first embodiment, as hereinabove described, the TV 2 is further provided with the remote controller 3 configured to operate the TV 2, and the MPU 26 is configured to perform control of shifting to the weight measurement mode configured to measure the weight by the operation of the remote controller 3. Thus, a shift to the weight measurement mode can be made with the remote controller 3 configured to operate the TV 2, and hence no operation portion for shifting the TV 2 to the weight measurement mode may be provided in the weight scale 1. Consequently, complication of the structure of the weight scale 1 can be suppressed.

According to the first embodiment, as hereinabove described, the weight scale 1 is further provided with the Bluetooth (registered trademark) communication portion 15 capable of communicating with the TV 2, and the MPU 16 is configured to perform control of transmitting the weight measurement result after calibration to the TV 2 through the Bluetooth (registered trademark) communication portion 15 after transmitting the weight measurement result before calibration to the TV 2. Thus, no display portion 25 configured to display the weight measurement results may be provided in the weight scale 1, and hence the structure of the weight scale 1 can be simplified. Furthermore, the weight measurement results can be displayed on the TV 2, and hence the user can be provided with the weight measurement results in the more visually-recognizable state.

According to the first embodiment, as hereinabove described, the MPU 26 is configured to perform control of displaying the inquiry to the user about the clothing worn by the user on the display portion 25, estimating the weight of the user in the case where the user wears no clothing on the basis of the response of the user to the inquiry with the remote controller 3, and displaying the measurement result of the weight of the user on the display portion 25. Thus, an accurate measurement result from which the weight of the clothing has been subtracted can be provided even when the user wears the clothing.

### Second Embodiment

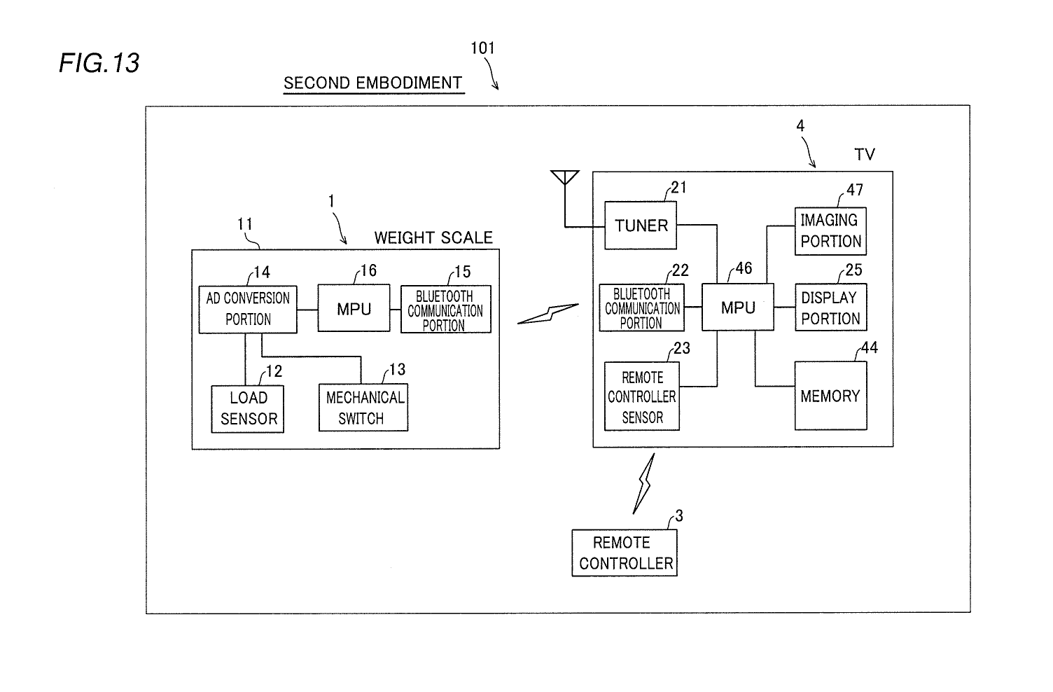

The structure of a weight measurement system 101 according to a second embodiment is now described with reference to FIGS. 13 to 18. In the second embodiment, an MPU 46 of a TV 4 is configured to perform control of displaying an inquiry allowing a user to select from among a plurality of images of clothing previously imaged by an imaging portion 47 provided in the TV 4 on a clothing selection screen, unlike the weight measurement system 100 according to the first embodiment including the MPU 26 of the TV 2 configured to perform control of displaying the inquiry allowing the user to select whether the user wears the “summer clothing”, the “winter clothing”, or “no clothing” through the clothing confirmation screen.

According to the second embodiment, the TV 4 includes a memory 44, the MPU 46, and the imaging portion 47, as shown in FIG. 13. The remaining structure of the TV 4 according to the second embodiment is similar to that of the TV 2 according to the first embodiment.

According to the second embodiment, the memory 44 is configured to store data on a measurement result of the weight of the user and the plurality of images imaged by the imaging portion 47. The MPU 46 is configured to perform control of shifting to a setting change mode configured to set whether to measure the weight of the user in the case where the user wears no clothing and set the weight of the clothing on the basis of the user's operation of a remote controller 3.

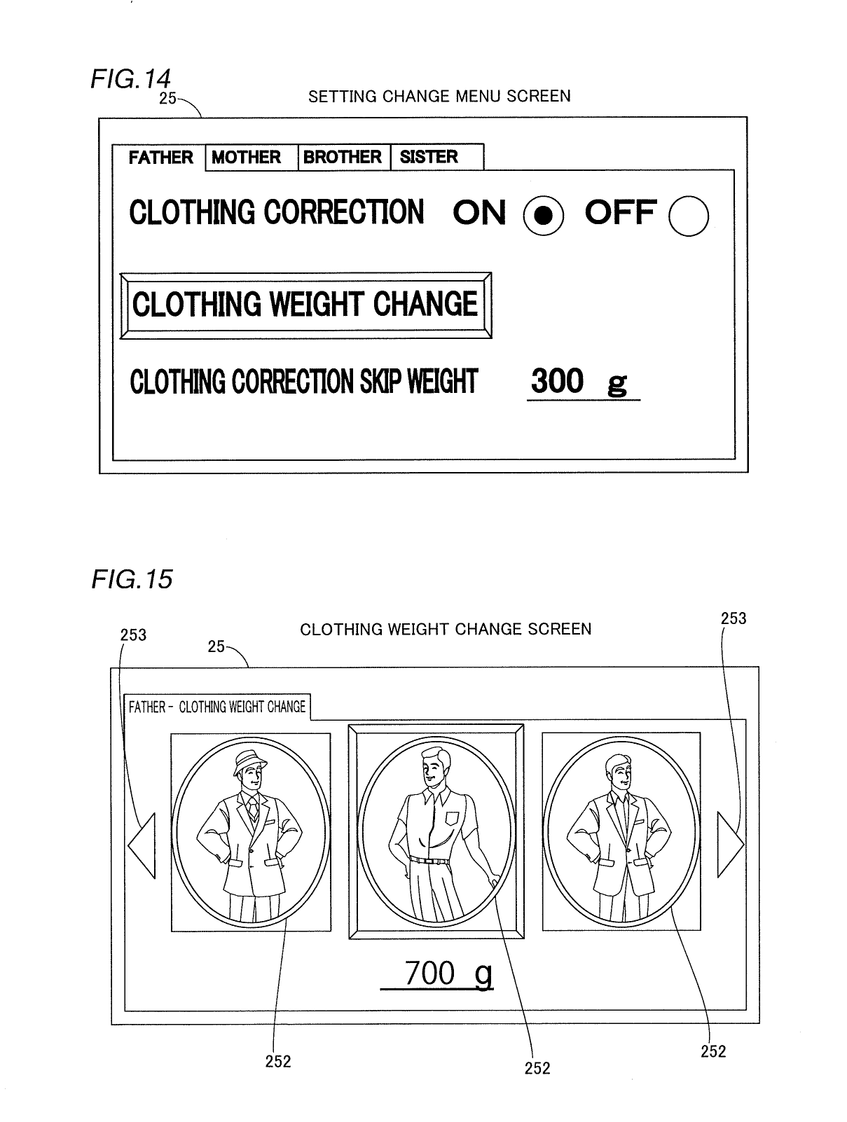

Specifically, the MPU 46 is configured to perform control of shifting to the setting change mode on the basis of the user's operation of the remote controller 3 and displaying a setting change menu screen on a display portion 25, as shown in FIG. 14. When the user determines that it is necessary to measure the weight of the user in the case where the user wears no clothing (correct clothing), “ON” in the item of “clothing correction” is selected by the user's operation of the remote controller 3. The MPU 46 performs control of displaying a selected item on the display portion 25 in order for the user to be capable of visually determining the selected item. FIG. 14 shows a state where “ON” is selected, for example. In this case, the MPU 46 is configured to perform control of displaying a weight measurement result before calibration not including the weight of the clothing (the weight measurement result of the user in the case where the user wears no clothing) and a weight measurement result after calibration on the display portion 25 in a weight measurement mode. When the user determines that it is not necessary to measure the weight of the user in the case where the user wears no clothing (correct clothing), “OFF” in the item of “clothing correction” is selected by the user's operation of the remote controller 3. In this case, the MPU 46 is configured to perform control of displaying a weight measurement result before calibration including the weight of the clothing and a weight measurement result after calibration including the weight of the clothing on the display portion 25 in the weight measurement mode.

According to the second embodiment, the MPU 46 is configured to perform control of displaying a clothing weight change screen (see FIG. 15) on the display portion 25 when the item of “clothing weight change” is selected by the user's operation of the remote controller 3, as shown in FIGS. 14 and 15. The MPU 46 perform control of displaying three of a plurality of images 252 previously imaged by the imaging portion 47 to be aligned in a single horizontal row and displaying a clothing weight change set value for setting the weight of the clothing on the lower side of a previously imaged image 252 displayed in the center of the three displayed images 252 that are previously imaged on the clothing weight change screen. The MPU 46 performs control of displaying two triangular selection buttons 253 on both ends of the three previously imaged images 252. This clothing weight change set value corresponds to the weight of the clothing of the previously imaged image 252 displayed in the center. In other words, the MPU 46 is configured to perform control of subtracting this clothing weight change set value from the weight measurement result before calibration when the weight of the user in the case where the user wears no clothing is measured and displaying the obtained result as the weight measurement result of the user in the case where the user wears no clothing.

The MPU 46 performs control of displaying previously imaged images 252 different from the first three displayed images 252 that are previously imaged when one of the two triangular selection buttons 253 is selected by the user's operation of the remote controller 3. When a triangular selection button 253 displayed on the right end is selected, for example, a previously imaged image 252 displayed on the right side is not displayed. The previously imaged image 252 displayed in the center is displayed in the position of the right image. A previously imaged image 252 displayed on the left side is displayed in the position of the central image.

An image different from the first three displayed images that are previously imaged is displayed in the position of the left image.

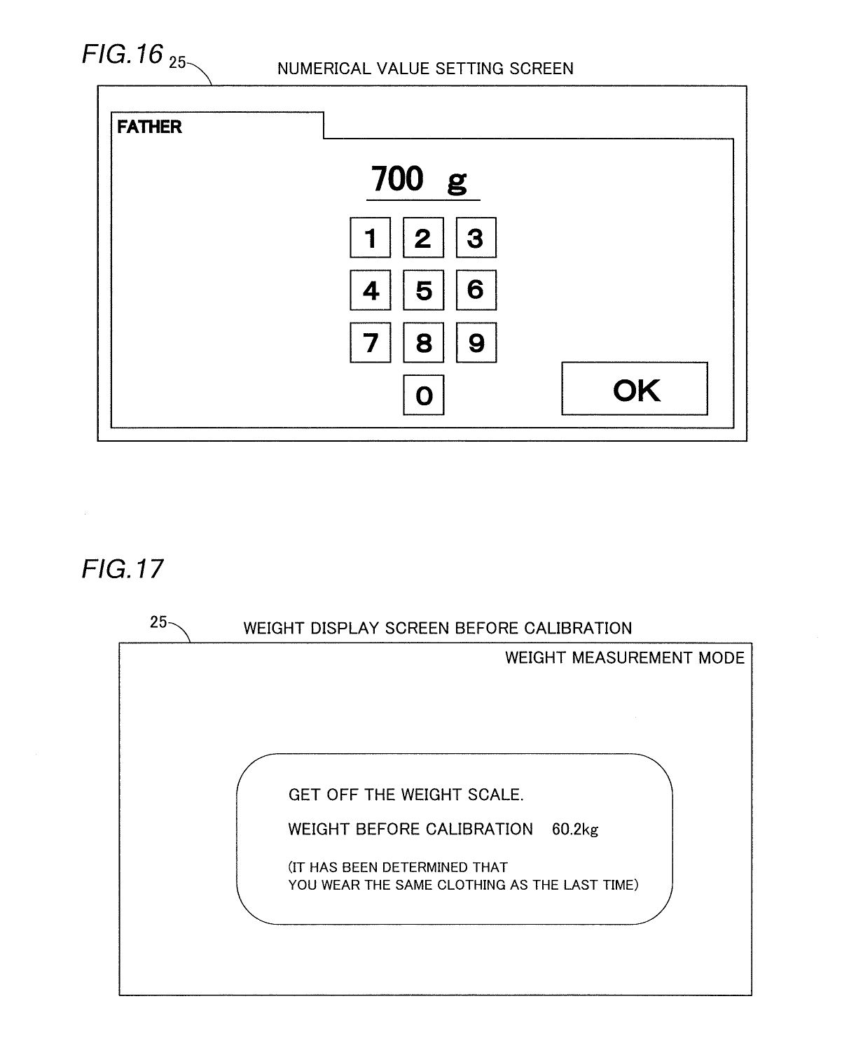

As shown in FIG. 16, the MPU 46 is configured to perform control of displaying a numerical value setting screen when an image in the clothing weight change screen is selected by the user's operation of the remote controller 3. Furthermore, the MPU 46 is configured to perform control of setting the arbitrary weight of the clothing by selecting numbers displayed on the display portion 25 by the user's operation of the remote controller 3. FIG. 16 shows the case where the weight of the clothing is set as 700 g.

The MPU 46 is configured to perform control of displaying the numerical value setting screen (see FIG. 16) on the display portion 25 when the item of “clothing correction skip weight” is selected by the user's operation of the remote controller 3 on the setting change menu screen, as shown in FIG. 14. Furthermore, the MPU 46 is configured to perform control of setting the value of the “clothing correction skip weight” displayed on the display portion 25 on the basis of the user's operation of the remote controller 3, similarly to the case of the aforementioned “clothing weight change”. FIG. 14 shows the case where the clothing correction skip weight is set as 300 g. The clothing correction skip weight is an example of the “prescribed threshold” in the present invention.

According to the second embodiment, the MPU 46 is configured to perform control of acquiring a difference between a first weight measurement result that is the weight measurement result before calibration and a second weight measurement result that is a weight measurement result before calibration prior to the weight measurement result before calibration and displaying the measurement result of the weight of the user in the case where the user wears no clothing on the display portion 25 on the basis of the weight of the clothing at the time of acquisition of the second weight measurement result without displaying an inquiry about the clothing when the difference is not larger than the clothing correction skip weight. Furthermore, the MPU 46 is configured to perform control of acquiring the difference between the first weight measurement result that is the weight measurement result before calibration and the second weight measurement result that is the weight measurement result before calibration prior to the weight measurement result before calibration, displaying the inquiry when the difference is larger than the clothing correction skip weight, and displaying the measurement result of the weight of the user in the case where the user wears no clothing on the display portion 25 on the basis of the response of the user to the inquiry with the remote controller 3.

Specifically, the MPU 46 calculates the difference between the first weight measurement result and the second weight measurement result that is the weight measurement result before calibration obtained at the time of previous weight measurement after the TV 4 receives the first weight measurement result from a weight scale 1 through a Bluetooth (registered trademark) communication portion 22. Then, the MPU 46 compares the difference with the clothing correction skip weight. Then, the MPU 46 performs control of displaying the measurement result of the weight of the user in the case where the user wears no clothing on the display portion 25, employing a value equal to the weight of the clothing employed at the time of the previous weight measurement, without the inquiry about the clothing described later when the difference is not larger than the clothing correction skip weight.

When the first weight measurement result is 60.0 kg, the second weight measurement result is 60.1 kg, and the clothing correction skip weight is 0.3 kg (300 g), for example, the difference is 0.1 kg and is not larger than 0.3 kg of the clothing correction skip weight so that the inquiry about the clothing is not displayed. The MPU 46 is configured to perform control of displaying the measurement result of the weight of the user in the case where the user wears no clothing on the display portion 25, employing the value equal to the weight of the clothing employed at the time of the previous weight measurement and displaying a message “it has been determined that you wear same clothing as last time” (see FIG. 17).

When the difference is larger than the clothing correction skip weight, on the other hand, the user conceivably wears clothing different from the previous clothing so that the inquiry about the clothing is made. When the first weight measurement result is 60.0 kg, the second weight measurement result is 61.0 kg, and the clothing correction skip weight is 0.3 kg (300 g), for example, the difference is 1.0 kg and is larger than 0.3 kg of the clothing correction skip weight so that the inquiry about the clothing is made. Then, the MPU 46 performs control of displaying the measurement result of the weight of the user in the case where the user wears no clothing on the display portion 25, employing the weight of the clothing corresponding to an image selected with respect to the inquiry about the clothing.

According to the second embodiment, the TV 4 includes the imaging portion 47 (see FIG. 13) imaging the clothing of the user, and the MPU 46 is configured to perform control of selectably displaying the plurality of images of the clothing previously imaged by the imaging portion 47 at the time of the inquiry about the clothing, estimating the weight of the user in the case where the user does not wear the clothing of the selected image on the basis of the selected image, and displaying the measurement result of the weight of the user in the case where the user does not wear the clothing of the image on the display portion 25.

Specifically, the MPU 46 (see FIG. 13) operates the imaging portion 47 provided in the TV 4 on the basis of the user's operation of the remote controller 3 and performs control of imaging an image of the appearance or clothing of the user before weight measurement. Then, the image imaged by the imaging portion 47 is stored in the memory 44. The weight of the clothing corresponding to the imaged image is set on the setting change menu screen described earlier on the basis of the user's operation of the remote controller 3. Then, the TV 4 shifts to the weight measurement mode on the basis of the user's operation of the remote controller 3, and weight measurement before calibration is started when the user gets on the weight scale 1.

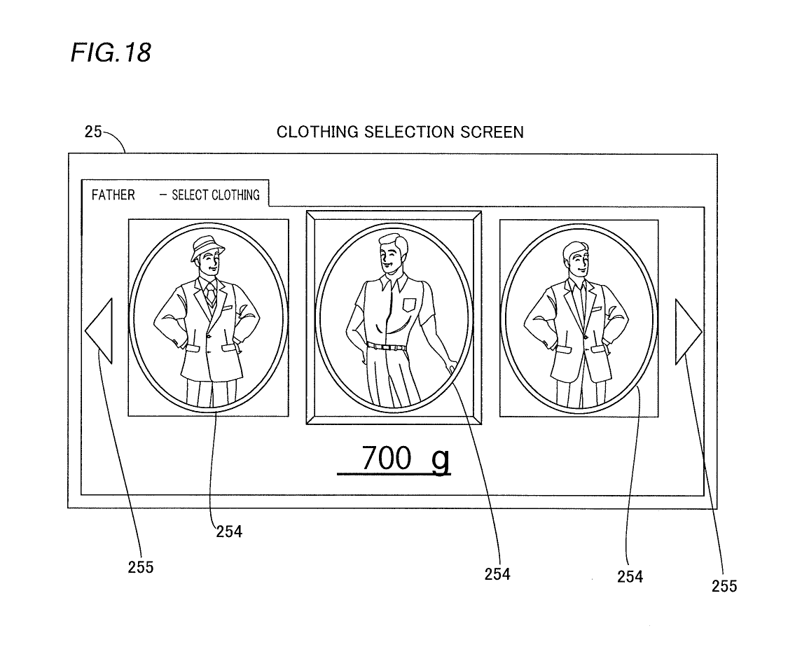

As shown in FIG. 18, the MPU 46 is configured to perform control of displaying three images 254 previously imaged by the imaging portion 47 to be aligned in a single horizontal row and displaying the weight of the clothing on the lower side of a previously imaged image 254 displayed in the center of the three previously imaged images 254 on a screen (hereinafter referred to as the clothing selection screen) for inquiring about the clothing. The MPU 46 performs control of displaying two triangular selection buttons 255 on both ends of the three previously imaged images 254. Then, the previously imaged images 254 or the triangular selection buttons 255 are selected by the user's operation of the remote controller 3. When the triangular selection buttons 255 are selected by the user's operation of the remote controller 3, an image (not shown) of clothing different from the first three displayed images 254 that are previously imaged is displayed. As shown in FIG. 18, the weight of the clothing corresponds to the weight of the clothing of the previously imaged image displayed in the center. Then, the MPU 46 obtains a difference between the weight of the clothing corresponding to a selected image 254 that is previously imaged and the weight measurement result before calibration when one of the three previously imaged images 254 is selected by the user's operation of the remote controller 3. Thereafter, the MPU 46 performs control of displaying the difference value as the weight of the user in the case where the user does not wear the clothing of the selected image on the display portion 25, as shown in FIG. 6.

The remaining structure of the weight measurement system 101 according to the second embodiment is similar to that of the weight measurement system 100 according to the aforementioned first embodiment.

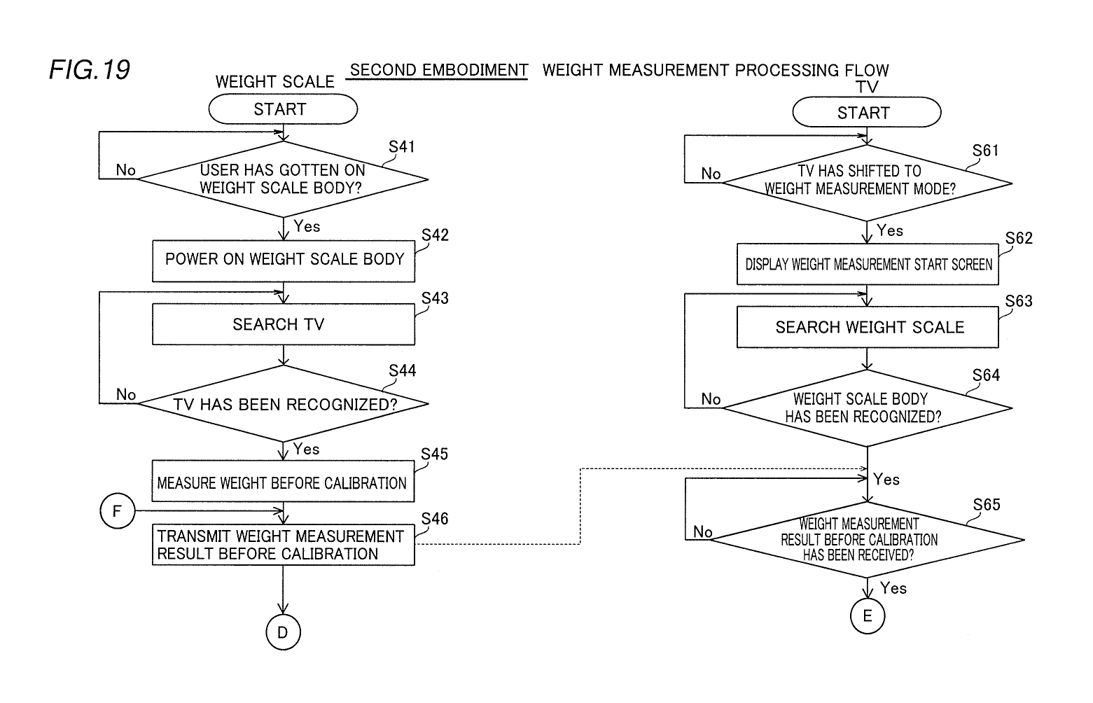

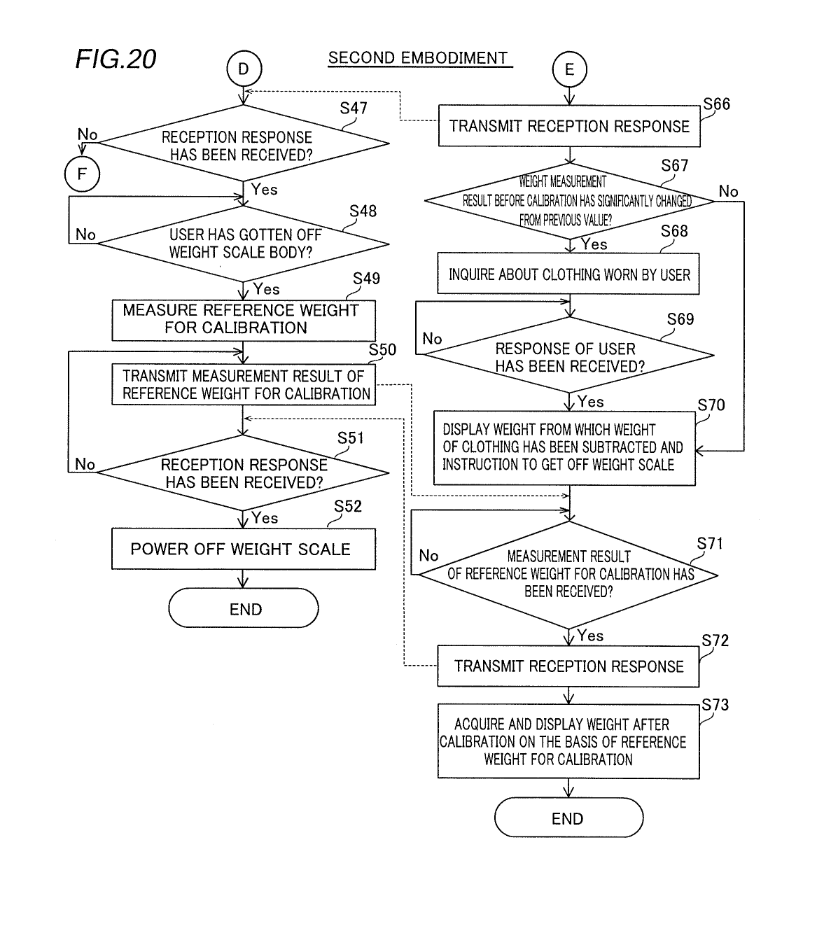

A flow of weight measurement processing performed by the weight measurement system 101 according to the second embodiment is now described with reference to FIGS. 19 and 20. Processing in the weight scale 1 is performed by an MPU 16, and processing in the TV 4 is performed by the MPU 46.

First, in the TV 4, the MPU 46 determines whether or not the TV 4 has shifted to the weight measurement mode at a step S61. The MPU 46 repeats this determination until the TV 4 shifts to the weight measurement mode and advances to a step S62 when the TV 4 shifts to the weight measurement mode.

At the step S62, a weight measurement start screen for instructing the user to get on a weight scale body 11 is displayed on the display portion 25. Then, the weight scale 1 is searched at a step S63.

At a step S64, the MPU 46 determines whether or not the weight scale body 11 has been recognized. When determining that the weight scale body 11 has not been recognized at the step S64, the MPU 46 returns to the step S63. When determining that the weight scale body 11 has been recognized at the step S64, the MPU 46 advances to a step S65.

On the other hand, in the weight scale 1, the MPU 16 determines whether or not the user has gotten on the weight scale body 11 at a step S41. The MPU 16 repeats this determination until the user gets on the weight scale body 11 and advances to a step S42 when the user gets on the weight scale body 11.

At the step S42, the weight scale body 11 is powered on when a mechanical switch 13 (see FIG. 13) detects that the user has gotten on the weight scale body 11. Then, the TV 4 is searched at a step S43.

At a step S44, the MPU 16 determines whether or not the TV 4 has been recognized. When determining that the TV 4 has not been recognized at the step S44, the MPU 16 returns to the step S43. When determining that the TV 4 has been recognized at the step S44, the MPU 16 advances to a step S45. At the step S45, the weight before calibration is measured.

At a step S46, the weight measurement result of the user before calibration is transmitted to the TV 4. Specifically, the weight measurement result of the user before calibration is transmitted from the weight scale 1 to the TV 4 through a Bluetooth (registered trademark) communication portion 15 (see FIG. 2).

In the TV 4, the MPU 46 determines whether or not the weight measurement result before calibration has been received at the step S65. The MPU 46 repeats this determination until the weight measurement result before calibration is received when determining that the weight measurement result before calibration has not been received at the step S65 and advances to a step S66 when the weight measurement result before calibration is received.

At the step S66, a reception response is transmitted. Thereafter, the MPU 46 advances to a step S67.

According to the second embodiment, the MPU 46 determines whether or not the weight measurement result before calibration has significantly changed from the previous value at the step S67. In other words, the MPU 46 advances to a step S68 when the difference between the received weight measurement result before calibration (first weight measurement result) and the previously measured weight measurement result before calibration (second weight measurement result) is larger than the clothing correction skip weight, and advances to a step S70 when the difference is not larger than the clothing correction skip weight.

At the step S68, the inquiry about the clothing worn by the user is made to the user. Specifically, the inquiry allowing the user to select the clothing worn by the user through the clothing confirmation screen is displayed on the display portion 25, as shown in FIG. 18.

Then, the MPU 46 determines whether or not the response of the user about the clothing worn by the user has been received at a step S69. The MPU 46 repeats this determination until the response of the user about the clothing worn by the user is received and advances to the step S70 when the response of the user about the clothing worn by the user is received.

At the step S70, the weight from which the weight of the clothing has been subtracted and an instruction to get off the weight scale are displayed on the display portion 25.

In the weight scale 1, the MPU 16 determines whether or not the reception response of the weight measurement result of the user before calibration transmitted from the TV 4 has been received at a step S47. When determining that the reception response of the weight measurement result of the user before calibration transmitted from the TV 4 has not been received at the step S47, the MPU 16 returns to the step S46. When determining that the reception response of the weight measurement result of the user before calibration transmitted from the TV 4 has been received at the step S47, the MPU 16 advances to a step S48.

At the step S48, the MPU 16 determines whether or not the user has gotten off the weight scale body 11 through the mechanical switch 13. The MPU 16 repeats this determination until the user gets off the weight scale body 11 and advances to a step S49 when the user gets off the weight scale body 11.

At the step S49, reference weight for calibration in a state where the user does not get on the weight scale body 11 is measured. Then, a measurement result of the reference weight for calibration is transmitted to the TV 4 at a step S50. Specifically, the measurement result of the reference weight for calibration is transmitted from the weight scale 1 to the TV 4 through the Bluetooth (registered trademark) communication portion 15.

In the TV 4, the MPU 46 determines whether or not the measurement result of the reference weight for calibration transmitted from the weight scale 1 has been received at a step S71. The MPU 46 repeats this determination until the measurement result of the reference weight for calibration is received and advances to a step S72 when the measurement result of the reference weight for calibration is received.

At the step S72, a reception response indicating that the measurement result of the reference weight for calibration has been received is transmitted to the weight scale 1. Then, the weight after calibration is acquired on the basis of the reference weight for calibration and is displayed at a step S73. Specifically, the reference weight for calibration is subtracted from the weight before calibration, whereby the weight measurement result after calibration is acquired. Then, the weight after calibration is displayed on the display portion 25 through a weight display screen after calibration, as shown in FIG. 6. Thereafter, a flow of measurement result acquisition processing is terminated.

In the weight scale 1, the MPU 16 determines whether or not the reception response of the measurement result of the reference weight for calibration has been received from the TV 4 at a step S51. When determining that the reception response of the measurement result of the reference weight for calibration has not been received from the TV 4 at the step S51, the MPU 16 returns to the step S50. When determining that the reception response of the measurement result of the reference weight for calibration has been received from the TV 4 at the step S51, the MPU 16 advances to a step S52. At the step S52, the weight scale 1 is powered off, and thereafter the flow of the weight measurement processing is terminated.

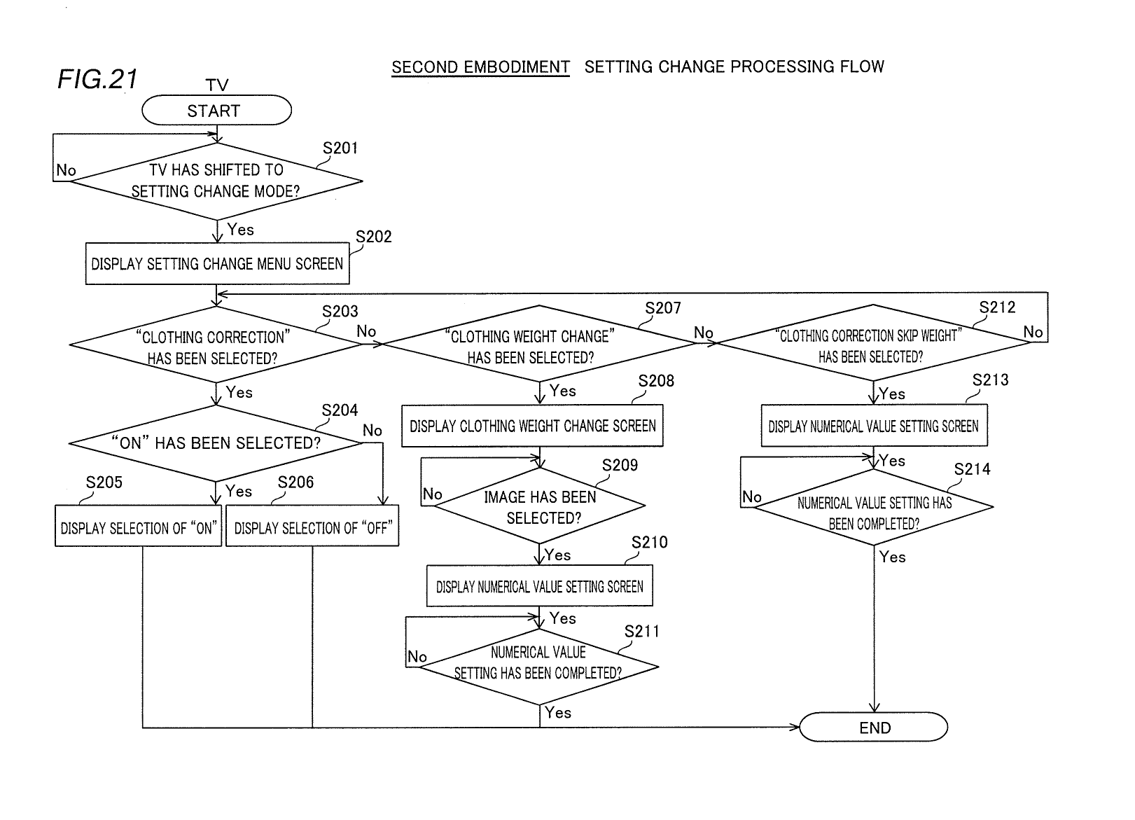

A flow of setting change processing performed by the weight measurement system 101 according to the second embodiment is now described with reference to FIG. 21. Processing in the TV 4 is performed by the MPU 46.

First, in the TV 4, the MPU 46 determines whether or not the TV 4 has shifted to a setting change mode on the basis of the user's operation of the remote controller 3 at a step S201. The MPU 46 repeats this determination until the TV 4 shifts to the setting change mode and advances to a step S202 when the TV 4 shifts to the setting change mode.

According to the second embodiment, the setting change menu screen shown in FIG. 14 is displayed at the step S202, and thereafter the MPU 46 advances to a step S203.

At the step S203, the MPU 46 determines whether or not the item of “clothing correction” has been selected. When determining that the item of “clothing correction” has not been selected, the MPU 46 advances to a step S207, and when determining that the item of “clothing correction” has been selected, the MPU 46 advances to a step S204.

At the step S204, the MPU 46 determines whether or not “ON” has been selected. When determining that “ON” has not been selected, the MPU 46 advances to a step S206, and when determining that “ON” has been selected, the MPU 46 advances to a step S205.

At the step S205, a selection of “ON” (see FIG. 14) is displayed on the display portion 25. Thereafter, the flow of the setting change processing is terminated.

At the step S206, a selection of “OFF” is displayed on the display portion 25. Thereafter, the flow of the setting change processing is terminated.

When determining that the item of “clothing correction” has not been selected at the step S203, the MPU 46 determines whether or not the item of “clothing weight change” has been selected at the step S207. When determining that the item of “clothing weight change” has not been selected, the MPU 46 advances to a step S212, and when determining that the item of “clothing weight change” has been selected, the MPU 46 advances to a step S208.

At the step S208, the clothing weight change screen (see FIG. 15) is displayed on the display portion 25. Thereafter, the MPU 46 advances to a step S209 and determines whether or not the image has been selected (see FIG. 18) at the step S209. When determining that the image has not been selected, the MPU 46 repeats this determination until the image is selected and advances to a step S210 when the image is selected.

At the step S210, the numerical value setting screen (see FIG. 16) is displayed on the display portion 25. Thereafter, the MPU 46 advances to a step S211 and determines whether or not numerical value setting has been completed at the step S211. When determining that the numerical value setting has not been completed, the MPU 46 repeats this determination until the numerical value setting is completed. After the numerical value setting is completed, the flow of the setting change processing is terminated.

When determining that the item of “clothing weight change” has not been selected at the step S207, the MPU 46 determines whether or not the item of “clothing correction skip weight” has been selected at the step S212. When determining that the item of “clothing correction skip weight” has not been selected, the MPU 46 returns to the step S203, and when determining that the item of “clothing correction skip weight” has been selected, the MPU 46 advances to a step S213.

At the step S213, the numerical value setting screen (see FIG. 16) is displayed on the display portion 25. Thereafter, the MPU 46 advances to a step S214 and determines whether or not numerical value setting has been completed at the step S214. When determining that the numerical value setting has not been completed, the MPU 46 repeats this determination until the numerical value setting is completed. After the numerical value setting is completed, the flow of the setting change processing is terminated.

According to the second embodiment, the following effects can be obtained.

According to the second embodiment, as hereinabove described, the MPU 46 is configured to perform control of acquiring the difference between the first weight measurement result that is the weight measurement result before calibration and the second weight measurement result that is the weight measurement result before calibration prior to the weight measurement result before calibration and displaying the measurement result of the weight of the user in the case where the user wears no clothing on the display portion 25 on the basis of the weight of the clothing at the time of acquisition of the second weight measurement result without displaying the inquiry when the difference is not larger than the clothing correction skip weight. Thus, in the case where the user wears the same clothing at the time of measurement of the first weight measurement result and at the time of measurement of the second weight measurement result and the difference value is small, display of the inquiry can be omitted, and hence a need for the user to respond to the inquiry can be eliminated while the weight of the clothing is considered. Consequently, the time required for one measurement can be reduced.

According to the second embodiment, as hereinabove described, the MPU 46 is configured to perform control of acquiring the difference between the first weight measurement result that is the weight measurement result before calibration and the second weight measurement result that is the weight measurement result before calibration prior to the weight measurement result before calibration, displaying the inquiry when the difference is larger than the clothing correction skip weight, and displaying the measurement result of the weight of the user in the case where the user wears no clothing on the display portion 25 on the basis of the response of the user to the inquiry with the remote controller 3. Thus, only in the case where the difference value is large and the user conceivably wears different clothing at the time of measurement of the first weight measurement result and at the time of measurement of the second weight measurement result, the inquiry is displayed, and hence display of the inquiry can be omitted in the other cases. Consequently, a need for the user to respond to the inquiry can be eliminated while the weight of the clothing is considered, and hence the time required for one measurement can be reduced.

According to the second embodiment, as hereinabove described, the MPU 46 is configured to perform control of shifting to the setting change mode configured to set whether or not to measure the weight of the user in the case where the user wears no clothing and set the weight of the clothing on the basis of the user's operation of the remote controller 3. Thus, the user himself/herself can determine whether or not to measure the weight of the user in the case where the user wears no clothing, and hence the user can be more promptly provided with the measurement result according to the request of the user. Furthermore, the weight of the clothing that the user owns can be set, and hence the user can be provided with an accurate measurement result from which the weight of the clothing has been subtracted.

According to the second embodiment, as hereinabove described, the TV 4 further includes the imaging portion 47 imaging the clothing of the user, and the MPU 46 is configured to perform control of selectably displaying the plurality of images of the clothing previously imaged by the imaging portion 47 at the time of the inquiry, estimating the weight of the user in the case where the user does not wear the clothing of the selected image on the basis of the selected image, and displaying the measurement result of the weight of the user in the case where the user does not wear the clothing of the selected image on the display portion 25. Thus, an image of the clothing can be displayed and selected, and hence the inquiry can be displayed in a more visually-recognizable state for the user. Furthermore, unlike the case where the weight of the user wearing no clothing is estimated on a rough basis of summer clothing and winter clothing, the clothing can be specified by the image of the clothing actually worn by the user, and hence the weight of the user wearing no clothing can be more accurately estimated.

The remaining effects of the weight measurement system 101 according to the second embodiment are similar to those of the weight measurement system 100 according to the aforementioned first embodiment.

### Third Embodiment

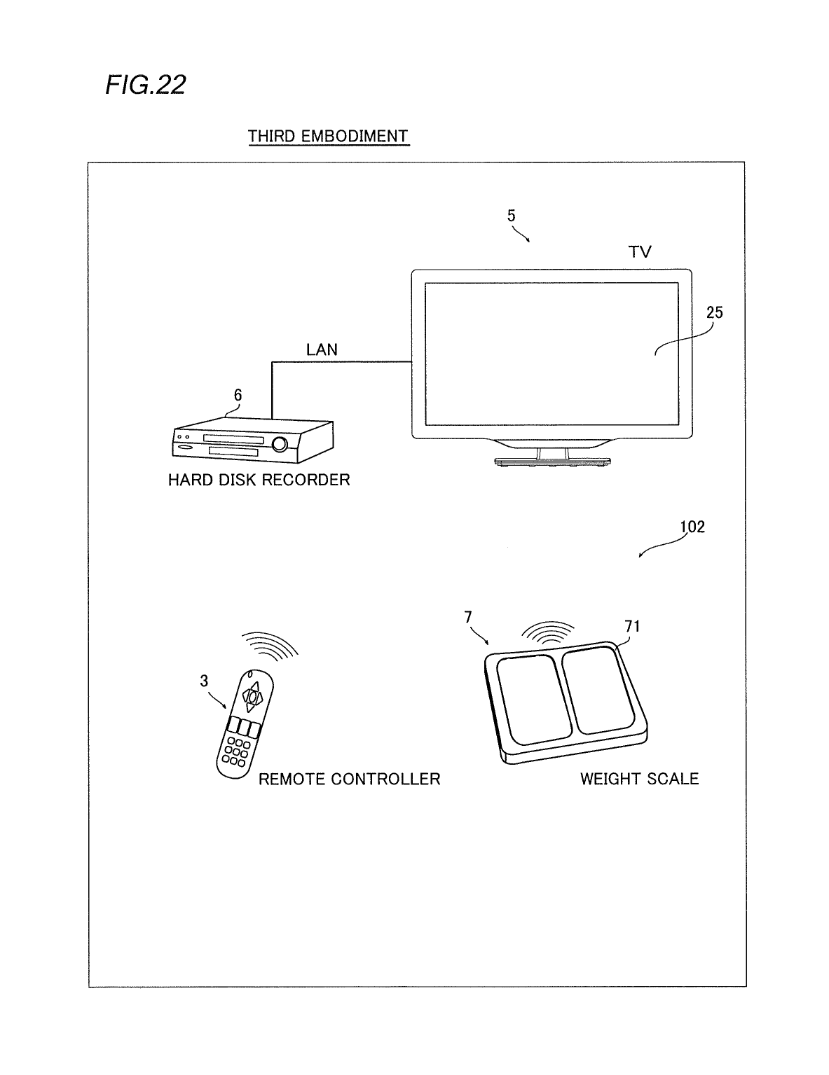

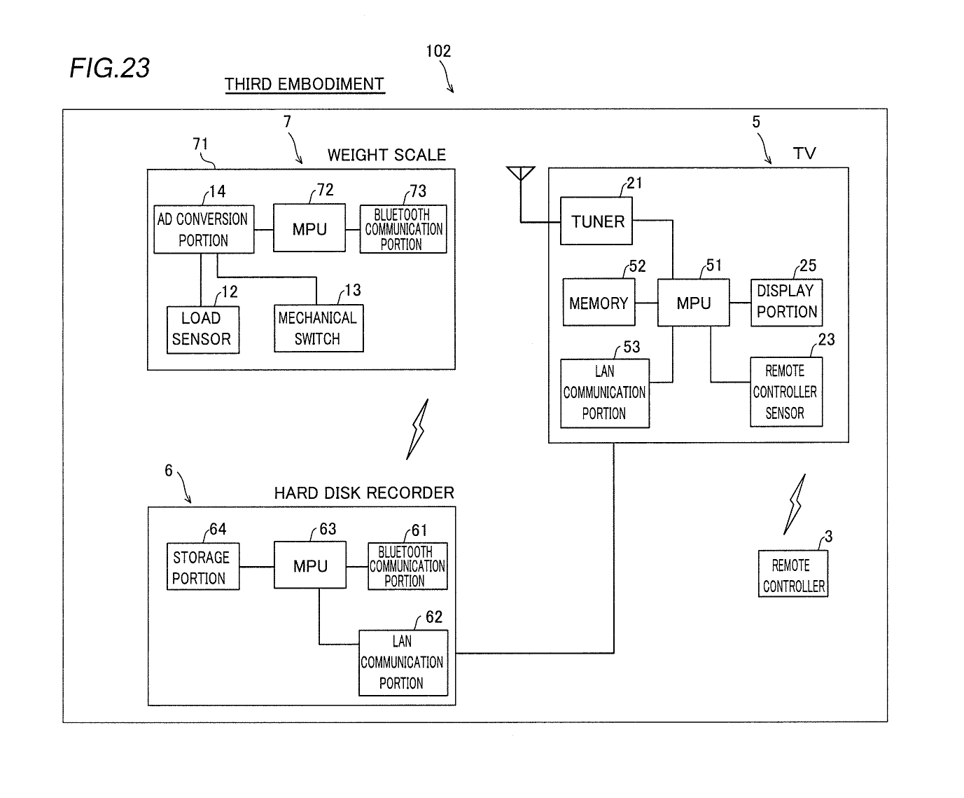

The structure of a weight measurement system 102 according to a third embodiment is now described with reference to FIGS. 22 and 23. According to the third embodiment, the weight measurement system 102 further includes a hard disk recorder 6 provided separately from a weight scale 7 and a TV 5.

As shown in FIGS. 22 and 23, the hard disk recorder 6 is connected to the TV 5 through a LAN. According to the third embodiment, the hard disk recorder 6 includes a Bluetooth (registered trademark) communication portion 61 receiving a measurement result from the weight scale 7, a storage portion 64 storing the measurement result received by the Bluetooth (registered trademark) communication portion 61, a LAN (local area network) communication portion 62 transmitting the measurement result stored in the storage portion 64 to the TV 5, and an MPU 63 and is provided separately from the weight scale 7 and the TV 5. The hard disk recorder 6 is an example of the “external storage device” in the present invention. The Bluetooth (registered trademark) communication portion 61 is an example of the “external storage device side receiving portion” in the present invention. The LAN communication portion 62 is an example of the “external storage device side transmitting portion” in the present invention.

Specifically, the MPU 63 of the hard disk recorder 6 receives a weight measurement result before calibration and a measurement result of reference weight for calibration from the weight scale 7 through the Bluetooth (registered trademark) communication portion 61 and thereafter stores the received weight measurement result and measurement result of the reference weight in the storage portion 64. The MPU 63 performs control of transmitting the weight measurement result and the measurement result of the reference weight stored in the storage portion 64 to the TV 5 through the LAN communication portion 62.

According to the third embodiment, the weight scale 7 includes a weight scale body 71, a Bluetooth (registered trademark) communication portion 73 transmitting the weight measurement result to the hard disk recorder 6, and an MPU 72. The Bluetooth (registered trademark) communication portion 73 is an example of the “measurement apparatus side communication portion” in the present invention.

According to the third embodiment, the TV 5 includes an MPU 51, a memory 52, and a LAN communication portion 53 receiving the weight measurement result from the hard disk recorder 6. The LAN communication portion 53 is an example of the “display device side communication portion” in the present invention.

The remaining structure of the weight measurement system 102 according to the third embodiment is similar to that of the weight measurement system 100 according to the aforementioned first embodiment.

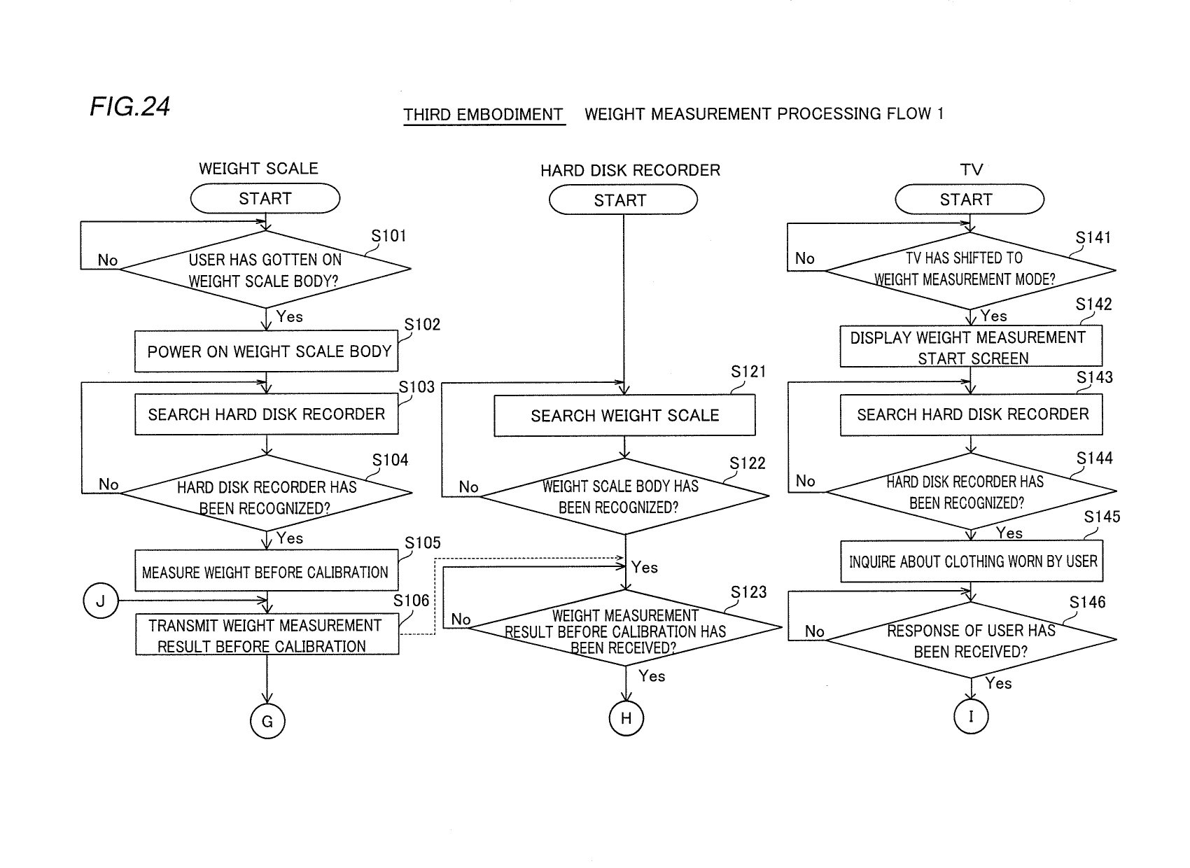

A flow of weight measurement processing performed by the weight measurement system 102 according to the third embodiment is now described with reference to FIGS. 24 to 26. Processing in the weight scale 7 is performed by the MPU 72, processing in the TV 5 is performed by the MPU 51, and processing in the hard disk recorder 6 is performed by the MPU 63.

First, in the TV 5, the MPU 51 determines whether or not the TV 5 has shifted to a weight measurement mode at a step S141, as shown in FIG. 24. The MPU 51 repeats this determination until the TV 5 shifts to the weight measurement mode and advances to a step S142 when the TV 5 shifts to the weight measurement mode.

At the step S142, a weight measurement start screen for instructing a user to get on the weight scale body 71 is displayed on a display portion 25. Then, the hard disk recorder 6 is searched at a step S143.

At a step S144, the MPU 51 determines whether or not the hard disk recorder 6 has been recognized. When determining that the hard disk recorder 6 has not been recognized at the step S144, the MPU 51 returns to the step S143. When determining that the hard disk recorder 6 has been recognized at the step S144, the MPU 51 advances to a step S145.

At the step S145, an inquiry about clothing worn by the user is made to the user. Specifically, the inquiry allowing the user to select whether the user wears “summer clothing”, “winter clothing”, or “no clothing” through a clothing confirmation screen is displayed on the display portion 25, as shown in FIG. 4.

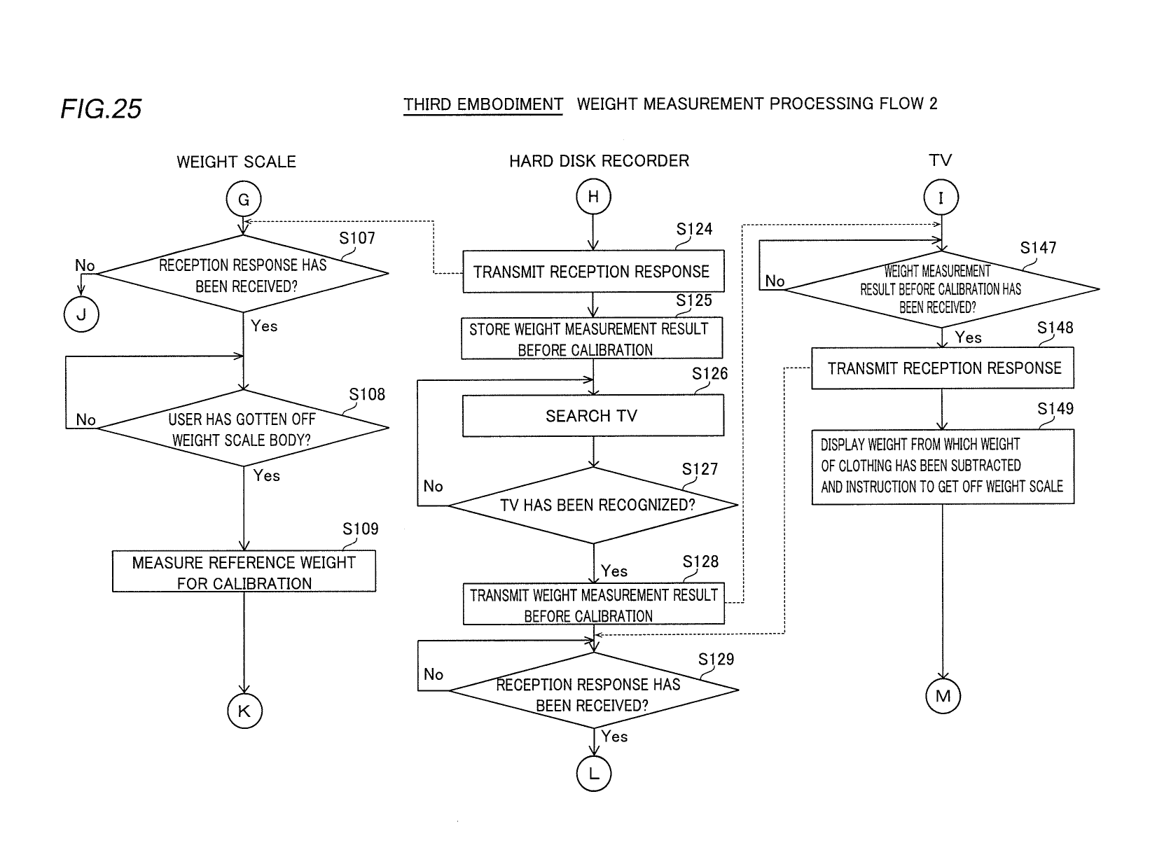

Then, the MPU 51 determines whether or not the response of the user about the clothing worn by the user has been received at a step S146. The MPU 51 repeats this determination until the response of the user about the clothing worn by the user is received and advances to a step S147 (see FIG. 25) when the response of the user about the clothing worn by the user is received.

On the other hand, in the weight scale 7, the MPU 72 determines whether or not the user has gotten on the weight scale body 71 at a step S101. The MPU 72 repeats this determination until the user gets on the weight scale body 71 and advances to a step S102 when the user gets on the weight scale body 71. When a mechanical switch 13 detects that the user has gotten on the weight scale body 71, the MPU 72 powers on the weight scale 7 and the weight of the user before calibration is measured.

At the step S102, the MPU 72 powers on the weight scale 7 when the mechanical switch 13 detects that the user has gotten on the weight scale body 71. Then, the hard disk recorder 6 is searched at a step S103.

At a step S104, the MPU 72 determines whether or not the hard disk recorder 6 has been recognized. When determining that the hard disk recorder 6 has not been recognized at the step S104, the MPU 72 returns to the step S103. When determining that the hard disk recorder 6 has been recognized at the step S104, the MPU 72 advances to a step S105.

At the step S105, the weight of the user before calibration is measured. Thereafter, the MPU 72 advances to a step S106.

At the step S106, a weight measurement result of the user before calibration is transmitted to the hard disk recorder 6. Specifically, the weight measurement result of the user before calibration is transmitted from the weight scale 7 to the hard disk recorder 6 through the Bluetooth (registered trademark) communication portion 73 (see FIG. 23).

In the hard disk recorder 6, the weight scale 7 is searched at a step S121. When determining that the weight scale body 71 has not been recognized at a step S122, the MPU 63 returns to the step S121. When determining that the weight scale body 71 has been recognized at the step S122, the MPU 63 advances to a step S123.

At the step S123, the MPU 63 determines whether or not the weight measurement result of the user before calibration has been received. When determining that the weight measurement result of the user before calibration has not been received at the step S123, the MPU 63 repeats this determination until the weight measurement result of the user before calibration is received and advances to a step S124 (see FIG. 25) when the weight measurement result of the user before calibration is received.

At the step S124, a reception response signal is transmitted to the weight scale 7. Then, the MPU 63 advances to a step S125.

At the step S125, the weight measurement result of the user before calibration is stored in the storage portion 64. Then, the MPU 63 advances to a step S126.

At the step S126, the TV 5 is searched. When determining that the TV 5 has not been recognized at a step S127, the MPU 63 returns to the step S126. When determining that the TV 5 has been recognized at the step S127, the MPU 63 advances to a step S128.

At the step S128, the weight measurement result before calibration is transmitted to the TV 5. Then, the MPU 63 advances to a step S129.

In the weight scale 7, the MPU 72 determines whether or not the reception response of the weight measurement result before calibration has been received at a step S107. When determining that the reception response of the weight measurement result before calibration has not been received at the step S107, the MPU 72 returns to the step S106. When determining that the reception response of the weight measurement result before calibration has been received at the step S107, the MPU 72 advances to a step S108.

At the step S108, the MPU 72 determines whether or not the user has gotten off the weight scale body 71 through the mechanical switch 13. The MPU 72 repeats this determination until the user gets off the weight scale body 71 and advances to a step S109 when the user gets off the weight scale body 71.

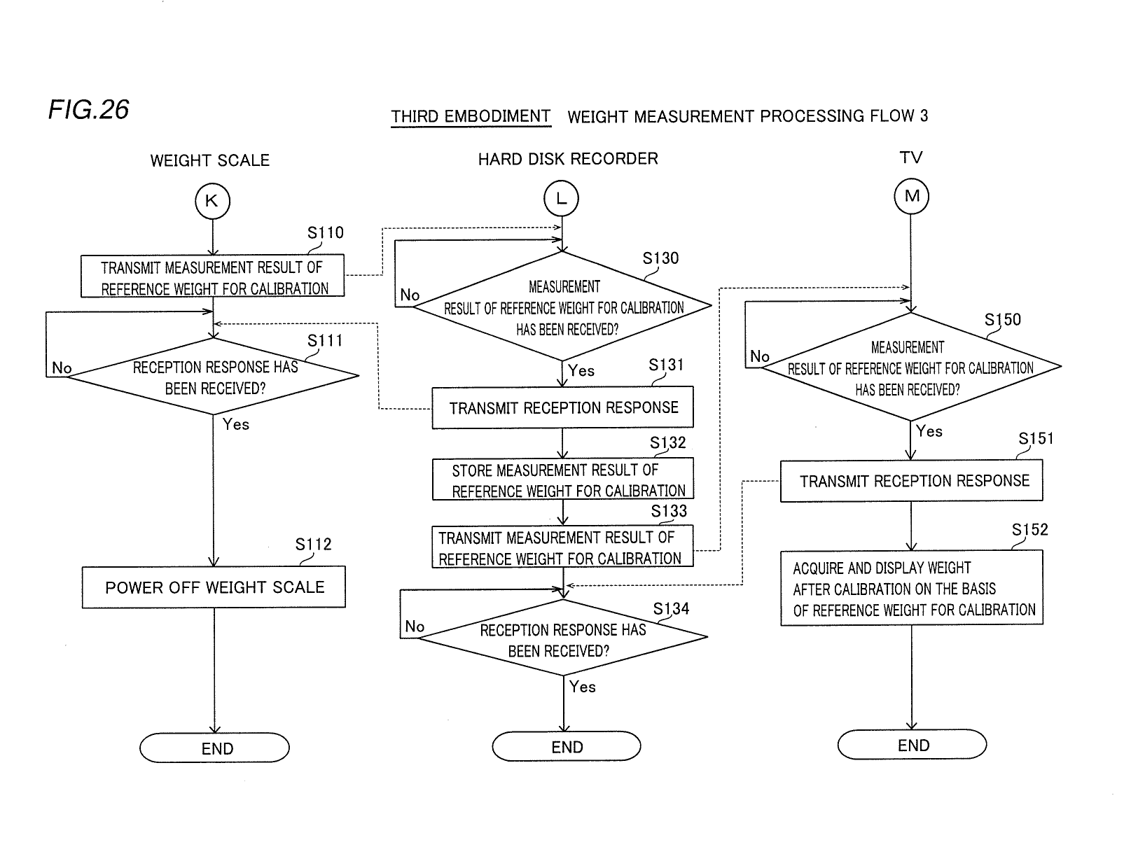

At the step S109, the reference weight for calibration in a state where the user does not get on the weight scale body 71 is measured. Then, the measurement result of the reference weight for calibration is transmitted to the hard disk recorder 6 at a step S110 (see FIG. 26).

In the TV 5, the MPU 51 determines whether or not the weight measurement result before calibration has been received from the hard disk recorder 6 at a step S147. The MPU 51 repeats this determination until the weight measurement result before calibration is received from the hard disk recorder 6 and advances to a step S148 when the weight measurement result before calibration is received from the hard disk recorder 6.

At the step S148, a reception response indicating that the weight measurement result of the user before calibration has been received is transmitted to the hard disk recorder 6. Then, at a step S149, an instruction to get off the weight scale body 71 and the weight measurement result before calibration from which the weight of the clothing has been subtracted are displayed on the display portion 25 through a weight display screen before calibration, as shown in FIG. 5.

As shown in FIG. 26, in the hard disk recorder 6, the MPU 63 determines whether or not the measurement result of the reference weight for calibration has been received from the weight scale 7 at a step S130. The MPU 63 repeats this determination until the measurement result of the reference weight for calibration is received from the weight scale 7 and advances to a step S131 when the measurement result of the reference weight for calibration is received from the weight scale 7.

At the step S131, the reception response of the measurement result of the reference weight for calibration is transmitted to the weight scale 7. Then, at a step S132, the measurement result of the reference weight for calibration is stored in the storage portion 64. At a step S133, the measurement result of the reference weight for calibration is transmitted to the TV 5.

In the weight scale 7, the MPU 72 determines whether or not the reception response of the measurement result of the reference weight for calibration transmitted from the hard disk recorder 6 has been received at a step S111. The MPU 72 repeats this determination until the reception response of the measurement result of the reference weight for calibration is received and advances to a step S112 when the reception response of the measurement result of the reference weight for calibration is received. Then, at the step S112, the weight scale 7 is powered off. Thereafter, the flow of the weight measurement processing is terminated.

In the TV 5, the MPU 51 determines whether or not the measurement result of the reference weight for calibration transmitted from the hard disk recorder 6 has been received at a step S150. The MPU 51 repeats this determination until the measurement result of the reference weight for calibration is received and advances to a step S151 when the measurement result of the reference weight for calibration is received.

At the step S151, a reception response is transmitted to the hard disk recorder 6. At a step S152, the weight after calibration is acquired on the basis of the reference weight for calibration and is displayed. Thereafter, a flow of measurement result acquisition processing is terminated.

In the hard disk recorder 6, the MPU 63 determines whether or not the reception response of the measurement result of the reference weight for calibration transmitted from the TV 5 has been received at a step S134. The MPU 63 repeats this determination until the reception response of the measurement result of the reference weight for calibration is received, and a flow of measurement result storage processing is terminated when the reception response of the measurement result of the reference weight for calibration is received.

According to the third embodiment, the following effects can be obtained.

According to the third embodiment, as hereinabove described, the weight measurement system 102 includes the Bluetooth (registered trademark) communication portion 61 receiving the measurement result from the weight scale 7, the storage portion 64 storing the measurement result received by the Bluetooth (registered trademark) communication portion 61, and the LAN communication portion 62 transmitting the measurement result stored in the storage portion 64 to the TV 5. Furthermore, the weight measurement system 102 is provided with the hard disk recorder 6 separately from the weight scale 7 and the TV 5. Thus, no storage portion may be provided in each of the weight scale 7 and the TV 5, and hence the structure of the weight scale 7 and the structure of the TV 5 can be simplified. In addition, even the TV 5 different from the TV 5 that has displayed the weight measurement results in the past can display the weight measurement results, and hence the TV 5 convenient to the user can be provided. The remaining effects of the weight measurement system 102 according to the third embodiment are similar to those of the weight measurement system 100 according to the aforementioned first embodiment.

The embodiments disclosed this time must be considered as illustrative in all points and not restrictive. The range of the present invention is shown not by the above description of the embodiments but by the scope of claims for patent, and all modifications within the meaning and range equivalent to the scope of claims for patent are further included.

For example, while the weight measurement result after calibration is displayed (output) for each weight measurement in each of the aforementioned first to third embodiments, the present invention is not restricted to this. According to the present invention, the weight measurement result after calibration may alternatively be displayed after a plurality of times of weight measurement. When the weight of the user is measured once a day, for example, only the weight measurement result before calibration may be displayed (output) for each of the plurality of times of weight measurement, and the weight measurement results after calibration may be collectively displayed after one week from the start of the weight measurement.

While the weight measurement result before calibration and the weight measurement result after calibration are displayed on (output to) the TV (display device) in each of the aforementioned first to third embodiments, the present invention is not restricted to this. According to the present invention, the weight measurement result before calibration and the weight measurement result after calibration may alternatively be output to the measurement apparatus having a weight measurement function. For example, a display portion may be provided in the measurement apparatus having a weight measurement function, and the weight measurement result before calibration and the weight measurement result after calibration may be displayed (output).

While the difference between the weight before calibration and the reference weight for calibration is calculated in the TV (display device) in each of the aforementioned first to third embodiments, the present invention is not restricted to this. According to the present invention, the difference between the weight before calibration and the reference weight for calibration may alternatively be calculated in the measurement apparatus having a weight measurement function.

While the weight of the user wearing no clothing is estimated on the basis of the response of the user to the inquiry about the clothing worn by the user in each of the aforementioned first to third embodiments, the present invention is not restricted to this. According to the present invention, the weight of the user wearing no clothing may alternatively be estimated by determining time and date or a season by a clock function that the display device has and inferring the clothing worn by the user, for example. Alternatively, the weight of the user wearing no clothing may be estimated by providing a camera in the display device and inferring the clothing worn by the user on the basis of an image of the user imaged by the camera.

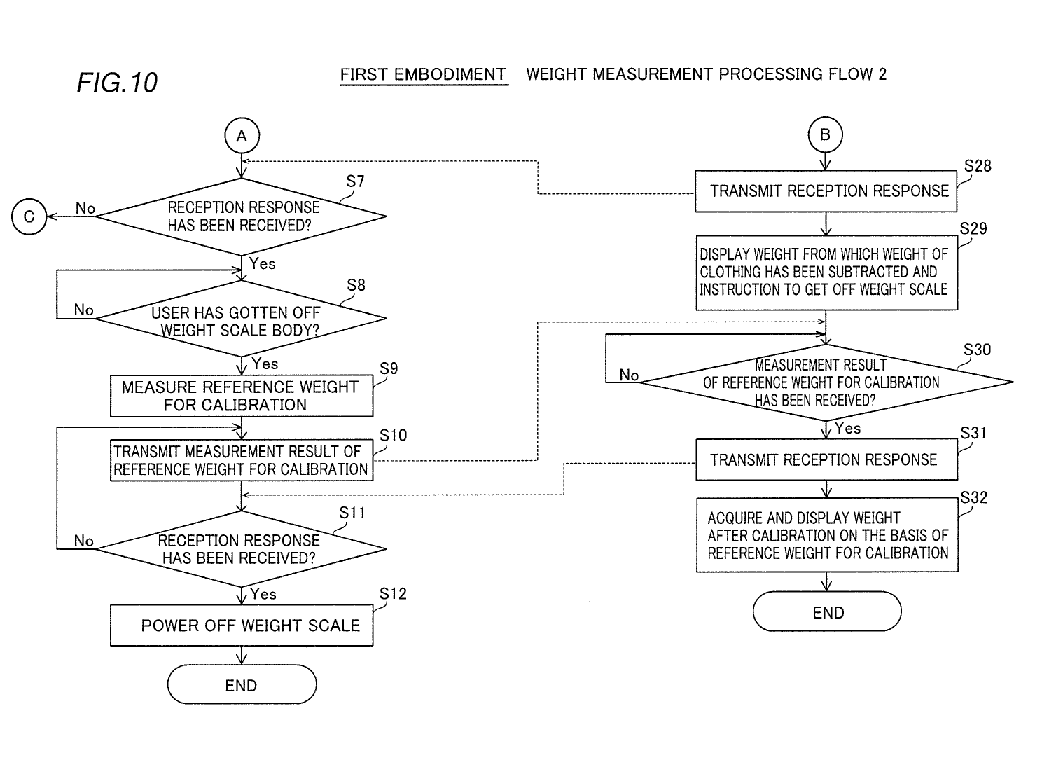

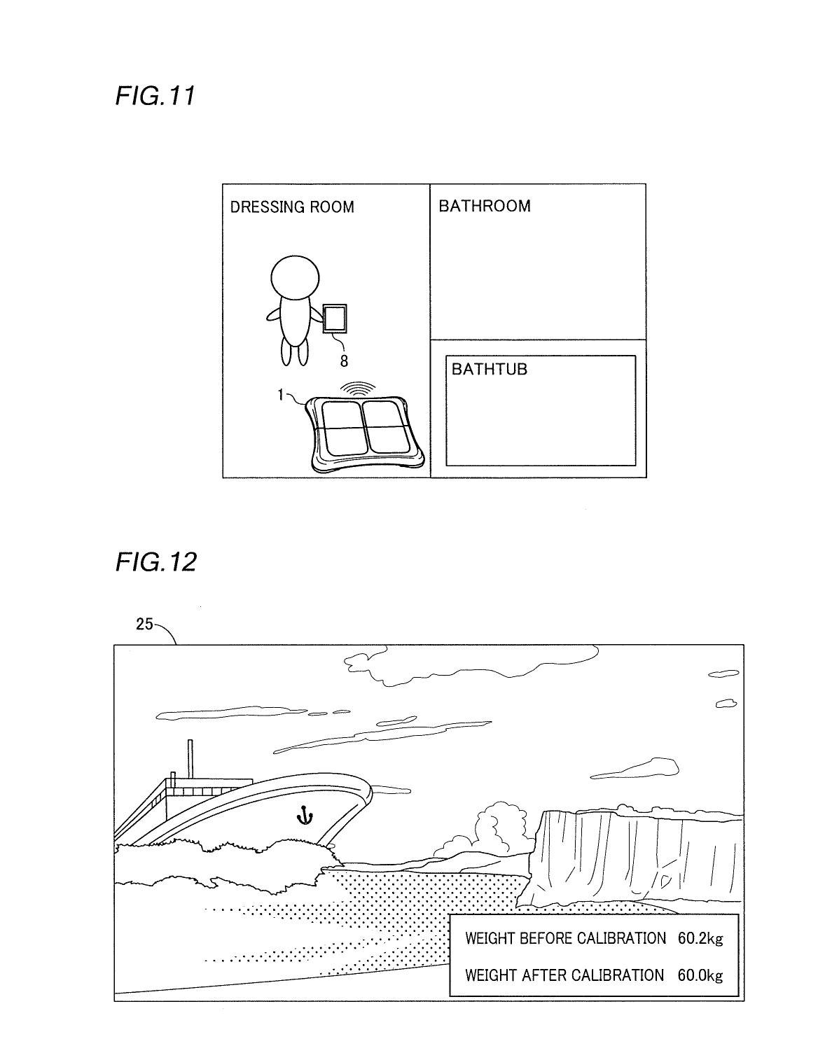

While the measurement result is transmitted from the weight scale (measurement apparatus having a weight measurement function) to the TV (display device) in each of the aforementioned first to third embodiments, the present invention is not restricted to this. According to the present invention, when the measurement apparatus having a weight measurement function does not recognize the TV 2 (when the user measures his/her weight with the measurement apparatus having a weight measurement function, arranged in a dressing room, for example), as shown in FIG. 11, the measurement result may alternatively be transmitted from the measurement apparatus having a weight measurement function to the smart phone 8 (portable terminal device) of the user. In this case, the portable terminal device is configured to perform the same processing as the steps S21 to S32 of the measurement result acquisition processing (see FIG. 10) performed by the MPU 26. Furthermore, the smart phone 8 of the user is previously registered in the measurement apparatus having a weight measurement function, whereby the measurement result can be prevented from being transmitted to the portable terminal device of a third person other than the user. The smart phone 8 is an example of the “portable terminal device”, the “display device”, or the “external display device” in the present invention.

While only the screens related to the weight measurement mode configured to measure the weight of the user are displayed when the weight of the user is measured in each of the aforementioned first to third embodiments, the present invention is not restricted to this. According to the present invention, the screens related to the weight measurement mode configured to measure the weight of the user may alternatively be displayed by an OSD (on-screen display) function while a received broadcast program is viewed, as shown in FIG. 12.

While the reference weight for calibration is measured after the weight measurement result before calibration is transmitted (output) in each of the aforementioned first to third embodiments, the present invention is not restricted to this. According to the present invention, in the case where the weight before calibration is measured, the user gets off the measurement apparatus having a weight measurement function, and thereafter the weight is output, the reference weight for calibration may alternatively be measured in parallel with the output of the weight. Thus, measurement of the reference weight for calibration can be more promptly started.

While the Bluetooth (registered trademark) communication portion is provided as the communication portion according to the present invention in each of the aforementioned first to third embodiments, the present invention is not restricted to this. According to the present invention, a communication portion, such as a communication portion of an infrared sensor, other than the Bluetooth (registered trademark) communication portion may alternatively be provided.

While the control portion powers on the measurement apparatus body when the mechanical switch (detection portion) detects that the user has gotten on the weight scale body (measurement apparatus body) in each of the aforementioned first to third embodiments, the present invention is not restricted to this. According to the present invention, the measurement apparatus body may alternatively be powered on manually.

While the second weight measurement result is the weight measurement result before calibration at the time of previous weight measurement in the aforementioned second embodiment, the present invention is not restricted to this. According to the present invention, the second weight measurement result may alternatively be a weight measurement result before calibration at the time of weight measurement prior to the previous one.

While the image of the clothing is imaged before weight measurement in the aforementioned second embodiment, the present invention is not restricted to this. According to the present invention, the image of the clothing may alternatively be imaged during weight measurement. Then, the weight of the clothing may alternatively be set by the user's operation of the remote controller during or after the weight measurement.

While the three previously imaged images are displayed on the display portion through the clothing selection screen for the inquiry about the clothing in the aforementioned second embodiment, the present invention is not restricted to this. According to the present invention, one or two previously imaged images may alternatively be displayed on the display portion, or four or more previously imaged images may alternatively be displayed on the display portion.

While the prescribed threshold is set to 300 g in the aforementioned second embodiment, the present invention is not restricted to this. According to the present invention, the prescribed threshold may alternatively be set to a set value other than 300 g. For example, the prescribed threshold may be set to 0 g, and the inquiry about the clothing may be made if there is at least a change in the weight measurement result before calibration.

While the hard disk recorder is employed as the external storage device according to the present invention in the aforementioned third embodiment, the present invention is not restricted to this. According to the present invention, a storage device other than the hard disk recorder may alternatively be employed as the external storage device. An SSD (solid state disk) storage device or the like may be employed, for example.

While the single measurement apparatus, the single TV, and the single hard disk recorder are provided in the weight measurement system in the aforementioned third embodiment, the present invention is not restricted to this. According to the present invention, measurement results measured by a plurality of measurement apparatuses may alternatively be transmitted to the single hard disk recorder (or a plurality of hard disk recorders) and be stored in the storage portion of the hard disk recorder. Furthermore, the measurement results may alternatively be transmitted from the single hard disk recorder (or the plurality of hard disk recorders) to a plurality of TVs and be displayed on the display portions of the plurality of TVs.

While the processing performed by the control portion according to the present invention is described, using the flowchart described in a flow-driven manner in which processing is performed in order along a processing flow for the convenience of illustration in each of the aforementioned first to third embodiments, the present invention is not restricted to this. According to the present invention, the processing performed by the control portion may alternatively be performed in an event-driven manner in which processing is performed on an event basis. In this case, the processing performed by the control portion may be performed in a complete event-driven manner or in a combination of an event-driven manner and a flow-driven manner.

What is claimed is:

1. A measurement apparatus having a weight measurement function, comprising:
a measurement apparatus body;
a measurement portion measuring weight; and
a measurement apparatus side control portion controlling a weight measurement operation performed by the measurement portion, wherein
the measurement apparatus side control portion is configured to perform control of outputting a weight measurement result before calibration after measuring weight of a user before calibration in a state where the user gets on the measurement apparatus body and measuring reference weight for calibration in a state where the user does not get on the measurement apparatus body and to perform control of acquiring a weight measurement result of the user after calibration on the basis of a difference between the weight of the user before calibration in the state where the user gets on the measurement apparatus body and the reference weight for calibration and outputting the weight measurement result after calibration.

2. The measurement apparatus having a weight measurement function according to claim 1, further comprising a detection portion detecting that the user has gotten on the measurement apparatus body, wherein
the measurement apparatus side control portion is configured to perform control of powering on the measurement apparatus body when the detection portion detects that the user has gotten on the measurement apparatus body.

3. The measurement apparatus having a weight measurement function according to claim 1, further comprising a measurement apparatus side communication portion capable of communicating with an external display device, wherein
the measurement apparatus side control portion is configured to perform control of transmitting the weight measurement result after calibration to the external display device through the measurement apparatus side communication portion after transmitting the weight measurement result before calibration to the external display device.

4. The measurement apparatus having a weight measurement function according to claim 1, further comprising a measurement apparatus side communication portion capable of communicating with an external storage device, wherein
the measurement apparatus side control portion is configured to perform control of transmitting the weight measurement result after calibration to the external storage device through the measurement apparatus side communication portion after transmitting the weight measurement result before calibration to the external storage device.

5. A display device comprising:
a display portion;
a display device side receiving portion receiving a measurement result of reference weight for calibration in a state where a user does not get on a measurement apparatus body from a measurement apparatus having a weight measurement function after receiving a weight measurement result before calibration in a state where the user gets on the measurement apparatus body from the measurement apparatus having a weight measurement function; and
a display device side control portion controlling a display operation displayed on the display portion, wherein
the display device side control portion is configured to perform control of displaying the weight measurement result before calibration on the display portion, acquiring a weight measurement result of the user after calibration on the basis of a difference between the weight measurement result before calibration and the reference weight for calibration, and displaying the weight measurement result after calibration on the display portion.

6. The display device according to claim 5, further comprising a remote controller configured to operate a display device body, wherein
the display device side control portion is configured to perform control of shifting to a weight measurement mode configured to measure weight of the user on the basis of a user's operation of the remote controller.

7. The display device according to claim 6, wherein
the display device side control portion is configured to perform control of displaying an inquiry to the user about clothing worn by the user on the display portion, estimating the weight of the user in a case where the user wears no clothing on the basis of a response of the user to the inquiry with the remote controller, and displaying a measurement result of the weight of the user in the case where the user wears no clothing on the display portion in the weight measurement mode.

8. The display device according to claim 7, wherein
the display device side control portion is configured to perform control of acquiring a difference between a first weight measurement result that is the weight measurement result before calibration and a second weight measurement result that is a weight measurement result before calibration prior to the weight measurement result before calibration and displaying the measurement result of the weight of the user in the case where the user wears no clothing on the display portion on the basis of weight of the clothing at time of acquisition of the second weight measurement result without displaying the inquiry when the difference is not larger than a prescribed threshold.

9. The display device according to claim 7, wherein
the display device side control portion is configured to perform control of acquiring a difference between a first weight measurement result that is the weight measurement result before calibration and a second weight measurement result that is a weight measurement result before calibration prior to the weight measurement result before calibration, displaying the inquiry when the difference is larger than a prescribed threshold, and displaying the measurement result of the weight of the user in the case where the user wears no clothing on the display portion on the basis of the response of the user to the inquiry with the remote controller.

10. The display device according to claim 7, wherein
the display device side control portion is configured to perform control of shifting to a setting change mode configured to set whether or not to measure the weight of the user in the case where the user wears no clothing and set weight of the clothing on the basis of the user's operation of the remote controller.

11. The display device according to claim 7, further comprising an imaging portion imaging the clothing of the user, wherein
the display device side control portion is configured to perform control of selectably displaying a plurality of images of clothing previously imaged by the imaging portion at time of the inquiry, estimating the weight of the user in a case where the user does not wear clothing of a selected image on the basis of the selected image, and displaying the measurement result of the weight of the user in the case where the user does not wear the clothing of the selected image on the display portion.

12. The display device according to claim 5, further comprising a display device side communication portion capable of communicating with an external storage device,
configured to receive the weight measurement result before calibration and the measurement result of the reference weight for calibration from the external storage device through the display device side communication portion.

13. A weight measurement system comprising:
a measurement apparatus having a weight measurement function, including a measurement apparatus body, a measurement portion measuring weight, and a measurement apparatus side control portion performing control of outputting a weight measurement result before calibration after measuring weight of a user before calibration in a state where the user gets on the measurement apparatus body and measuring reference weight for calibration in a state where the user does not get on the measurement apparatus body; and
a display device including a display portion, a display device side receiving portion receiving a measurement result from the measurement apparatus having a weight measurement function, and a display device side control portion controlling a display operation displayed on the display portion, wherein
either the measurement apparatus side control portion or the display device side control portion is configured to perform control of acquiring a weight measurement result of the user after calibration on the basis of a difference between the weight of the user before calibration in a state where the user gets on the measurement apparatus body measured by the measurement portion and the reference weight for calibration, and
the display device side control portion is configured to perform control of displaying the weight measurement result after calibration on the display portion after displaying the weight measurement result before calibration on the display portion.

14. The weight measurement system according to claim 13, further comprising a detection portion detecting that the user has gotten on the measurement apparatus body, wherein
the measurement apparatus side control portion is configured to perform control of powering on the measurement apparatus body when the detection portion detects that the user has gotten on the measurement apparatus body.

15. The weight measurement system according to claim 13, wherein
the display device includes at least one of a stationary television set and a portable terminal device.

16. The weight measurement system according to claim 15, further comprising a remote controller configured to operate the stationary television set as the display device, wherein
the display device side control portion is configured to perform control of shifting to a weight measurement mode configured to measure weight of the user on the basis of a user's operation of the remote controller.

17. The weight measurement system according to claim 16, wherein
the display device side control portion is configured to perform control of displaying an inquiry to the user about clothing worn by the user on the display portion, estimating the weight of the user in a case where the user wears no clothing on the basis of a response of the user to the inquiry with the remote controller, and displaying a measurement result of the weight of the user on the display portion in the weight measurement mode.

18. The weight measurement system according to claim 17, wherein
the display device side control portion is configured to perform control of acquiring a difference between a first weight measurement result that is the weight measurement result before calibration and a second weight measurement result that is a weight measurement result before calibration prior to the weight measurement result before calibration and displaying the measurement result of the weight of the user in the case where the user wears no clothing on the display portion on the basis of weight of the clothing at time of acquisition of the second weight measurement result without displaying the inquiry when the difference is not larger than a prescribed threshold.

19. The weight measurement system according to claim 15, wherein
the measurement apparatus side control portion is configured to perform control of transmitting at least the weight measurement result before calibration in the state where the user gets on the measurement apparatus body to the portable terminal device in a case where the stationary television set is not recognized when transmitting at least the weight measurement result before calibration in the state where the user gets on the measurement apparatus body to the stationary television set.

20. The weight measurement system according to claim 13, further comprising an external storage device side receiving portion receiving a measurement result from the measurement apparatus having a weight measurement function, a storage portion storing the measurement result received by the external storage device side receiving portion, an external storage device side transmitting portion transmitting the measurement result stored in the storage portion to the display device, and an external storage device provided separately from the measurement apparatus and the display device.
